(19) United States
(12) Patent Application Publication
(10) Pub. No.: US 2026/0084416 A1
(43) Pub. Date: Mar. 26, 2026

(54) Liquid Discharge Apparatus And Head Unit

(71) Applicant: SEIKO EPSON CORPORATION, Tokyo (JP)

(72) Inventor: Toru KASHIMURA, Shiojiri (JP)

(21) Appl. No.: 19/339,516

(22) Filed: Sep. 25, 2025

(30) Foreign Application Priority Data
Sep. 26, 2024 (JP) 2024-167733

(51) Int. Cl. B41J 2/045; B41J 2/14

(52) U.S. Cl. CPC B41J 2/04548; B41J 2/04541; B41J 2/0457; B41J 2/04581; B41J 2/14233; B41J 2002/14491

(57) ABSTRACT

A liquid discharge apparatus includes a head including a first discharge section and a second discharge section, a first drive circuit, a second drive circuit, and a startup control circuit that controls startup of the first drive circuit and the second drive circuit, in which the first drive circuit outputs a signal for stopping output of a head power supply signal from a power supply circuit when the head power supply signal is equal to or lower than a predetermined voltage, the second drive circuit outputs a signal for stopping output of a drive circuit power supply signal from the power supply circuit when the drive circuit power supply signal is equal to or lower than a predetermined voltage, and the startup control circuit starts a startup sequence of the first drive circuit, and then starts a startup sequence of the second drive circuit.

The present application is based on, and claims priority from JP Application Serial Number 2024-167733, filed Sep. 26, 2024, the disclosure of which is hereby incorporated by reference herein in its entirety.

### BACKGROUND

### 1. Technical Field

The present disclosure relates to a liquid discharge apparatus and a head unit.

### 2. Related Art

As a liquid discharge apparatus such as an ink jet printer for discharging ink to print an image or a document, for example, a liquid discharge apparatus using a piezoelectric element, such as a piezo element, is known. The piezoelectric element is provided corresponding to each of a plurality of nozzles in a head, and is driven in accordance with a drive signal. As a result, a predetermined amount of liquid is discharged from the nozzle formed in the head at a predetermined timing, and dots are formed on a printing medium.

In such a liquid discharge apparatus, in order to control the supply of the drive signal to the piezoelectric element, for example, a high voltage of 42 V is supplied to the head as a power supply voltage. When an abnormality such as an overvoltage or an overcurrent occurs in a path through which such a power supply voltage propagates, there is a probability that the liquid discharge apparatus fails. Meanwhile, JP-A-2020-116867 discloses a liquid discharge apparatus that monitors a power supply voltage supplied to a head by a plurality of drive circuits and provides a fuse on a wiring path through which the power supply voltage propagates.

However, when a voltage of the drive signal is higher than the high voltage supplied to the head, there is a likelihood that an excessive current flows from a drive signal wiring to a power supply wiring for the head due to a parasitic diode existing in the head, to cause the failure of the head. In particular, such a situation is likely to occur when a plurality of drive circuits are started up.

### SUMMARY

According to an aspect of the present disclosure, there is provided a liquid discharge apparatus including: a head including a first discharge section that includes a first drive section driven by a first drive signal and that discharges liquid onto a medium in response to driving of the first drive section, and a second discharge section that includes a second drive section driven by a second drive signal and that discharges liquid onto the medium in response to driving of the second drive section; a transport section that transports the medium; a first drive circuit that outputs the first drive signal; a second drive circuit that outputs the second drive signal; and a startup control circuit that controls startup of the first drive circuit and the second drive circuit, in which a head power supply signal is supplied to the head, a drive circuit power supply signal is supplied to the first drive circuit and the second drive circuit, the first drive circuit outputs a signal for stopping output of the head power supply signal from a power supply circuit when the head power supply signal is equal to or lower than a predetermined voltage, the second drive circuit outputs a signal for stopping output of the drive circuit power supply signal from the power supply circuit when the drive circuit power supply signal is equal to or lower than a predetermined voltage, and the startup control circuit starts a startup sequence of the first drive circuit, and then starts a startup sequence of the second drive circuit.

According to another aspect of the present disclosure, there is provided a head unit including: a head including a first discharge section that includes a first drive section driven by a first drive signal and that discharges liquid onto a medium in response to driving of the first drive section, and a second discharge section that includes a second drive section driven by a second drive signal and that discharges liquid onto the medium in response to driving of the second drive section; a first drive circuit that outputs the first drive signal; a second drive circuit that outputs the second drive signal; and a startup control circuit that controls startup of the first drive circuit and the second drive circuit, in which a head power supply signal is supplied to the head, a drive circuit power supply signal is supplied to the first drive circuit and the second drive circuit, the first drive circuit outputs a signal for stopping output of the head power supply signal from a power supply circuit when the head power supply signal is equal to or lower than a predetermined voltage, the second drive circuit outputs a signal for stopping output of the drive circuit power supply signal from the power supply circuit when the drive circuit power supply signal is equal to or lower than a predetermined voltage, and the startup control circuit starts a startup sequence of the first drive circuit, and then starts a startup sequence of the second drive circuit.

### BRIEF DESCRIPTION OF THE DRAWINGS

FIG. 1 is a perspective view illustrating a schematic configuration of a liquid discharge apparatus.

FIG. 2 is a block diagram illustrating an electrical configuration of the liquid discharge apparatus.

FIG. 3 is a diagram illustrating an example of a drive signal.

FIG. 4 is a block diagram illustrating an electrical configuration of a drive signal selection circuit.

FIG. 5 is a circuit diagram illustrating an electrical configuration of a selection circuit.

FIG. 6 is a diagram illustrating decoded contents in a decoder.

FIG. 7 is a diagram illustrating an operation of the drive signal selection circuit.

FIG. 8 is a cross-sectional view illustrating a schematic configuration of a discharge section.

FIG. 9 is a block diagram illustrating a circuit configuration of a drive circuit substrate in a first embodiment.

FIG. 10 is a diagram illustrating a configuration example of an overcurrent protection circuit.

FIG. 11 is a block diagram illustrating a configuration of a drive circuit.

FIG. 12 is a diagram illustrating an example of a startup sequence of the drive circuit.

FIG. 13 is a block diagram illustrating a circuit configuration of a drive circuit substrate in a second embodiment.

FIG. 14 is a block diagram illustrating a circuit configuration of a drive circuit substrate in a third embodiment.

FIG. 15 is a block diagram illustrating a circuit configuration of a drive circuit substrate in a fourth embodiment.

### DESCRIPTION OF EMBODIMENTS

Hereinafter, preferred embodiments of the present disclosure will be described with reference to the accompanying drawings. The drawings to be used are for convenience of description. The embodiments described below are not intended to unduly limit the content of the present disclosure as set forth in the claims. Further, the configurations described below are not necessarily all essential constituent elements of the present disclosure.

### 1. First Embodiment

### 1-1. Configuration of Liquid Discharge Apparatus

A printing apparatus as an example of a liquid discharge apparatus according to the present embodiment is an ink jet printer that forms dots on a printing medium such as paper by discharging ink in accordance with image data input from an external host computer, and prints an image including characters, figures, and the like in accordance with the image data.

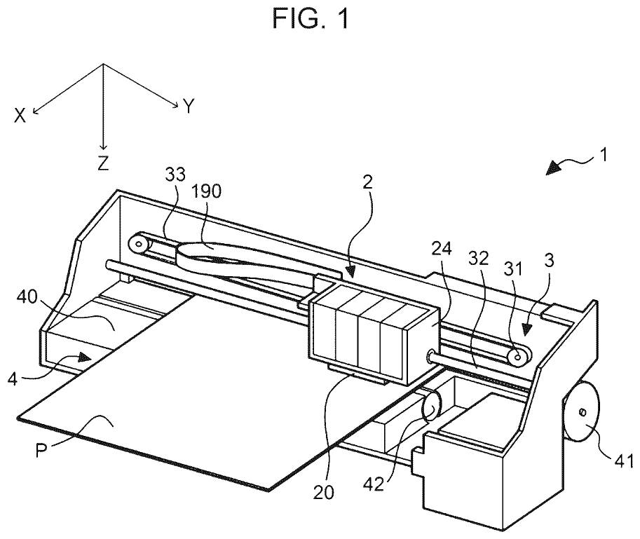

FIG. 1 is a perspective view illustrating a schematic configuration of a liquid discharge apparatus 1. FIG. 1 illustrates a direction X in which a medium P is transported, a direction Y which intersects the direction X and in which a moving object 2 reciprocates, and a direction z in which ink is discharged. In the present embodiment, the directions X, Y, and Z are described as axes orthogonal to each other, but the present disclosure is not limited to the configuration in which various configurations of the liquid discharge apparatus 1 are disposed orthogonal to each other. In the following description, the direction Y in which the moving object 2 moves may be referred to as a main scanning direction.

The liquid discharge apparatus 1 includes, as illustrated in FIG. 1, the moving object 2 and a moving mechanism 3 that causes the moving object 2 to reciprocate in the direction Y. The moving mechanism 3 includes a carriage motor 31 as a drive source of the moving object 2, a carriage guide shaft 32 of which both ends are fixed, and a timing belt 33 that extends substantially parallel to the carriage guide shaft 32 and is driven by the carriage motor 31.

A carriage 24 included in the moving object 2 is supported by the carriage guide shaft 32 to be able to reciprocate, and is fixed to a part of the timing belt 33. Then, the carriage 24 is guided by the carriage guide shaft 32 to reciprocate in the direction Y by driving the timing belt 33 via the carriage motor 31. A head unit 20 including a large number of nozzles is provided in a portion of the moving object 2 facing the medium P. A control signal or the like is input to the head unit 20 through a cable 190. The head unit 20 discharges ink as an example of liquid from the nozzle based on the input control signal.

The liquid discharge apparatus 1 includes a transport mechanism 4 that transports the medium P on a platen 40 in the direction X. The transport mechanism 4 includes a transport motor 41 as a drive source, and a transport roller 42 that is rotated by the transport motor 41 to transport the medium P in the direction X.

In the liquid discharge apparatus 1 configured in this manner, the head unit 20 discharges the ink at a timing when the medium P is transported by the transport mechanism 4, and thus the image is formed on a surface of the medium P.

### 1-2. Electrical Configuration of Liquid Discharge Apparatus

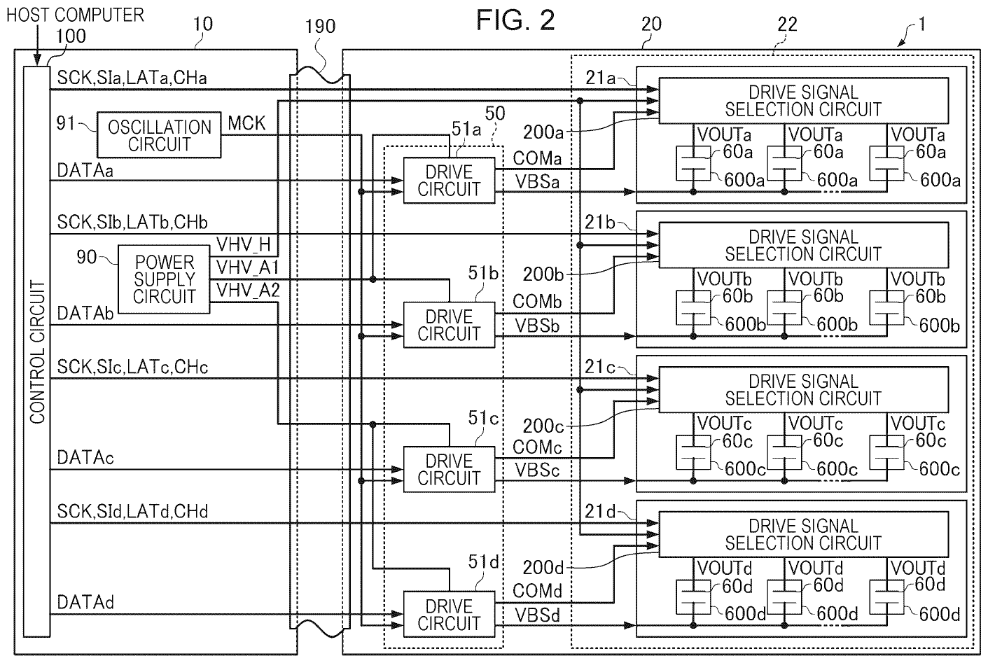

FIG. 2 is a block diagram illustrating an electrical configuration of the liquid discharge apparatus 1. The liquid discharge apparatus 1 includes, as illustrated in FIG. 2, a control unit 10 and the head unit 20. The control unit 10 and the head unit 20 are electrically coupled by the cable 190 such as a flexible flat cable (FFC).

The control unit 10 includes a control circuit 100, a power supply circuit 90, and an oscillation circuit 91. Then, the control circuit 100 generates a plurality of control signals and the like for controlling various configurations, based on the image data input from the host computer, and outputs the generated control signals and the like to the head unit 20.

Specifically, the control circuit 100 outputs a clock signal SCK, a printing data signals SIa, SIb, SIc, and SId, latch signals LATa, LATb, LATc, and LATd, change signals CHa, CHb, CHc, and CHd, and drive data signals DATAa, DATAB, DATAc, and DATAd to the head unit 20.

Although not illustrated, the control circuit 100 controls the carriage motor 31 and the transport motor 41. As a result, the movement of the carriage 24 in the direction Y illustrated in FIG. 1 or the movement of the medium P in the direction X illustrated in FIG. 1 is controlled.

The power supply circuit 90 generates, for example, voltages VHV_H, VHV_A1, and VHV_A2 of DC 42 V. Then, the power supply circuit 90 supplies the voltages VHV_H, VHV_A1, and VHV_A2 to the head unit 20.

The oscillation circuit 91 outputs a clock signal MCK. The clock signal MCK, which is output from the oscillation circuit, 91 is input to the head unit 20. The oscillation circuit 91 may be configured to be independent of the control circuit 100 as illustrated in FIG. 2 or may be configured inside the control circuit 100.

The head unit 20 includes a print head 22 and a drive circuit substrate 50. The drive circuit substrate 50 is coupled to the print head 22.

The drive circuit substrate 50 includes drive circuits 51a, 51b, 51c, and 51d. The drive circuits 51a, 51b, 51c, and 51d drive liquid discharge modules 21a, 21b, 21c, and 21d included in the print head 22, respectively.

The drive circuit 51a generates a drive signal COMa and a reference voltage signal VBSa based on the voltage VHV_A1, the drive data signal DATAa, and the clock signal MCK, and outputs the generated drive signal COMa and reference voltage signal VBSa to the liquid discharge module 21a. Further, the drive circuit 51b generates a drive signal COMb and a reference voltage signal VBSb based on the voltage VHV_A1, the drive data signal DATAb, and the clock signal MCK, and outputs the generated drive signal COMb and reference voltage signal VBSb to the liquid discharge module 21b. Further, the drive circuit 51c generates a drive signal COMc and a reference voltage signal VBSc based on the voltage VHV_A2, the drive data signal DATAc, and the clock signal MCK, and outputs the generated drive signal COMc and reference voltage signal VBSc to the liquid discharge module 21c. Further, the drive circuit 51d generates a drive signal COMd and a reference voltage signal VBSd based on the voltage VHV_A2, the drive data signal DATAd, and the clock signal MCK, and outputs the generated drive signal COMd and reference voltage signal VBSd to the liquid discharge module 21d. Here, the reference voltage signals VBSa, VBSb, VBSc, and VBSd are signals having a constant voltage, and are, for example, signals having a ground potential, a voltage of DC 5 V, a voltage of DC 6 V, and the like.

Although not illustrated in FIG. 2 in order to avoid complication, the drive circuit substrate 50 also includes circuits other than the drive circuits 51a, 51b, 51c, and 51d, and details of a circuit configuration and an operation of the drive circuit substrate 50 will be described later.

The print head 22 includes the liquid discharge modules 21a, 21b, 21c, and 21d. The liquid discharge module 21a includes a drive signal selection circuit 200a and a plurality of discharge sections 600a. In addition, each of the discharge sections 600a includes a piezoelectric element 60a. The clock signal SCK, the printing data signal SIa, the latch signal LATa, the change signal CHa, the drive signal COMa, and the voltage VHV_H are input to the drive signal selection circuit 200a. Then, the drive signal selection circuit 200a generates a drive signal VOUTa by selecting or not selecting the drive signal COMa based on the clock signal SCK, the printing data signal SIa, the latch signal LATa, the change signal CHa, and the voltage VHV_H.

The drive signal VOUTa is supplied to one end of the piezoelectric element 60a included in each of the plurality of discharge sections 600a. Further, the reference voltage signal VBSa is supplied to the other end of the piezoelectric element 60a. Then, the piezoelectric element 60a is driven by a potential difference between the drive signal VOUTa and the reference voltage signal VBSa, so that the ink is discharged from the discharge section 600a. That is, the liquid discharge module 21a includes the piezoelectric element 60a driven by the drive signal COMa, and the drive signal selection circuit 200a that controls the supply of the drive signal COMa to the piezoelectric element 60a.

The liquid discharge module 21b includes a drive signal selection circuit 200b and a plurality of discharge sections 600b. In addition, each of the discharge sections 600b includes a piezoelectric element 60b. The clock signal SCK, the printing data signal SIb, the latch signal LATb, the change signal CHb, the drive signal COMb, and the voltage VHV_H are input to the drive signal selection circuit 200b. Then, the drive signal selection circuit 200b generates a drive signal VOUTb by selecting or not selecting the drive signal COMb based on the clock signal SCK, the printing data signal SIb, the latch signal LATb, the change signal CHb, and the voltage VHV_H.

The drive signal VOUTb is supplied to one end of the piezoelectric element 60b included in each of the plurality of discharge sections 600b. Further, the reference voltage signal VBSb is supplied to the other end of the piezoelectric element 60b. Then, the piezoelectric element 60b is driven by a potential difference between the drive signal VOUTb and the reference voltage signal VBSb, so that the ink is discharged from the discharge section 600b. That is, the liquid discharge module 21b includes the piezoelectric element 60b driven by the drive signal COMb, and the drive signal selection circuit 200b that controls the supply of the drive signal COMb to the piezoelectric element 60b.

The liquid discharge module 21c includes a drive signal selection circuit 200c and a plurality of discharge sections 600c. In addition, each of the discharge sections 600c includes a piezoelectric element 60c. The clock signal SCK, the printing data signal SIc, the latch signal LATc, the change signal CHc, the drive signal COMc, and the voltage VHV_H are input to the drive signal selection circuit 200c. Then, the drive signal selection circuit 200c generates a drive signal VOUTc by selecting or not selecting the drive signal COMc based on the clock signal SCK, the printing data signal SIc, the latch signal LATc, the change signal CHc, and the voltage VHV_H.

The drive signal VOUTc is supplied to one end of the piezoelectric element 60c included in each of the plurality of discharge sections 600c. Further, the reference voltage signal VBSc is supplied to the other end of the piezoelectric element 60c. Then, the piezoelectric element 60c is driven by a potential difference between the drive signal VOUTc and the reference voltage signal VBSc, so that the ink is discharged from the discharge section 600c. That is, the liquid discharge module 21c includes the piezoelectric element 60c driven by the drive signal COMc, and the drive signal selection circuit 200c that controls the supply of the drive signal COMc to the piezoelectric element 60c.

The liquid discharge module 21d includes a drive signal selection circuit 200d and a plurality of discharge sections 600d. In addition, each of the discharge sections 600d includes a piezoelectric element 60d. The clock signal SCK, the printing data signal SId, the latch signal LATd, the change signal CHd, the drive signal COMd, and the voltage VHV_H are input to the drive signal selection circuit 200d. Then, the drive signal selection circuit 200d generates a drive signal VOUTd by selecting or not selecting the drive signal COMd based on the clock signal SCK, the printing data signal SId, the latch signal LATd, the change signal CHd, and the voltage VHV_H.

The drive signal VOUTd is supplied to one end of the piezoelectric element 60d included in each of the plurality of discharge sections 600d. Further, the reference voltage signal VBSd is supplied to the other end of the piezoelectric element 60d. Then, the piezoelectric element 60d is driven by a potential difference between the drive signal VOUTd and the reference voltage signal VBSd, so that the ink is discharged from the discharge section 600d. That is, the liquid discharge module 21d includes the piezoelectric element 60d driven by the drive signal COMd, and the drive signal selection circuit 200d that controls the supply of the drive signal COMd to the piezoelectric element 60d.

In the following description, the drive circuits 51a, 51b, 51c, and 51d have the same configuration, and may be referred to as the drive circuit 51 when there is no need to particularly distinguish the drive circuits 51a, 51b, 51c, and 51d. Various signals input to the drive circuit 51 are referred to as a voltage VHV, a drive data signal DATA, and a clock signal MCK. In addition, various signals output from the drive circuit 51 are referred to as a drive signal COM and a reference voltage signal VBS.

Further, the liquid discharge modules 21a, 21b, 21c, and 21d have the same configuration, and are referred to as a liquid discharge module 21 when there is no need to particularly distinguish the liquid discharge modules 21a, 21b, 21c, and 21d. In addition, the description will be made in which the liquid discharge module 21 includes a drive signal selection circuit 200 and a plurality of discharge sections 600, and the plurality of discharge sections 600 include piezoelectric elements 60. In such a case, various signals input to the liquid discharge module 21 are referred to as the clock signal SCK, the printing data signal SI, the latch signal LAT, the change signal CH, the drive signal COM, the reference voltage signal VBS, and the voltage VHV_H. In addition, the signal supplied to the piezoelectric element 60 is referred to as a drive signal VOUT.

### 1-3. Configuration and Operation of Liquid Discharge Module

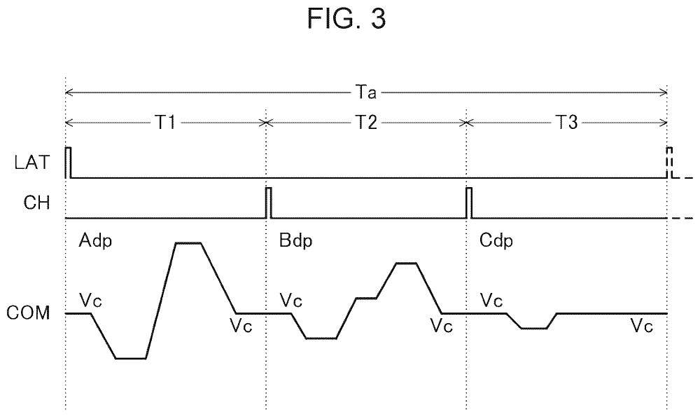

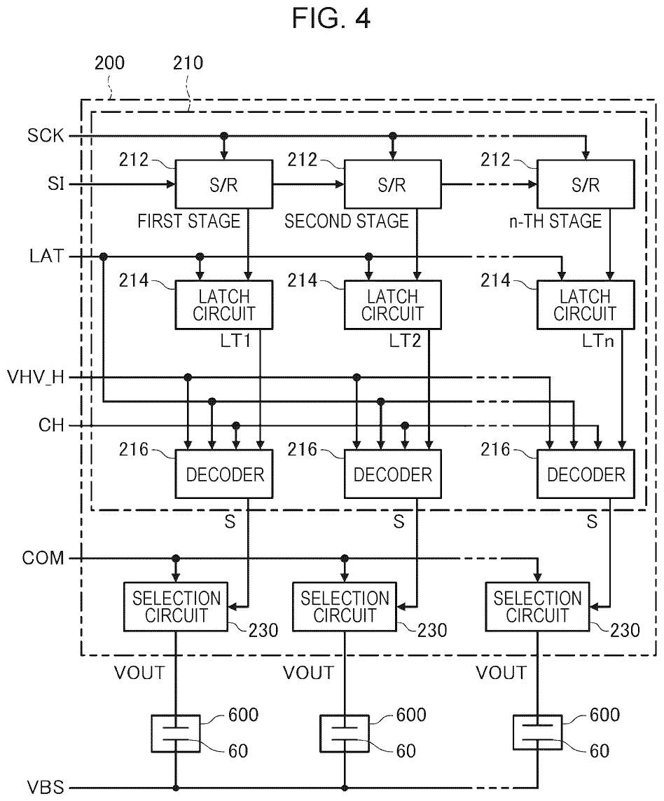

Next, a configuration and an operation of the drive signal selection circuit 200 will be described. In describing the configuration and the operation of the drive signal selection circuit 200, first, an example of the drive signal COM input to the drive signal selection circuit 200 will be described with reference to FIG. 3. Thereafter, the configuration and the operation of the drive signal selection circuit 200 will be described with reference to FIGS. 4 to 7.

FIG. 3 is a diagram illustrating an example of the drive signal COM. FIG. 3 illustrates a period T1 from a rising edge of the latch signal LAT to a rising edge of the change signal CH, a period T2 that follows the period T1 and extends to a next rising edge of the change signal CH, and a period T3 that follows the period T2 and extends to a rising edge of the latch signal LAT. A cycle formed by the periods T1, T2, and T3 is a cycle Ta for forming new dots on the medium P. That is, as illustrated in FIG. 3, the latch signal LAT is a signal that defines a cycle in which new dots are formed on the medium P, and the change signal CH is a signal that defines a switching timing of a waveform included in the drive signal COM.

As illustrated in FIG. 3, the drive circuit 51 generates a trapezoidal waveform Adp in the period T1. When the trapezoidal waveform Adp is supplied to the piezoelectric element 60, a predetermined amount, specifically, a medium amount of ink is discharged from the corresponding discharge section 600. Further, the drive circuit 51 generates a trapezoidal waveform Bdp in the period T2. When the trapezoidal waveform Bdp is supplied to the piezoelectric element 60, a small amount of ink smaller than the predetermined amount is discharged from the corresponding discharge section 600. Further, the drive circuit 51 generates a trapezoidal waveform Cdp in the period T3. When the trapezoidal waveform Cdp is supplied to the piezoelectric element 60, the piezoelectric element 60 is driven to such an extent that the ink is not discharged from the corresponding discharge section 600. Therefore, dots are not formed on the medium P when the trapezoidal waveform Cdp is supplied to the piezoelectric element 60. The trapezoidal waveform Cdp is a waveform for performing micro-vibration of the ink near a nozzle opening portion of the discharge section 600, to prevent viscosity of the ink from increasing. In the following description, driving the piezoelectric element 60 to such an extent that the ink is not discharged from the discharge section 600 in order to prevent the viscosity of the ink from increasing is referred to as “micro-vibration”.

Here, a voltage value at a start timing and a voltage value at an end timing of each of the trapezoidal waveform Adp, the trapezoidal waveform Bdp, and the trapezoidal waveform Cdp are both common to a voltage Vc. That is, the trapezoidal waveforms Adp, Bdp, and Cdp are waveforms that start at the voltage Vc and end at the voltage Vc. Therefore, the drive circuit 51 outputs the drive signal COM having a waveform in which the trapezoidal waveforms Adp, Bdp, and Cdp are continuous in the cycle Ta. The waveform of the drive signal COM illustrated in FIG. 3 is merely an example, and the waveform of the drive signal COM may be a different waveform. The drive circuit 51a and the drive circuit 51b may generate the drive signal COM having different waveforms and output the generated drive signal COM.

FIG. 4 is a block diagram illustrating an electrical configuration of the drive signal selection circuit 200. The drive signal selection circuit 200 generates the drive signal VOUT to be supplied to the piezoelectric element 60 and outputs the generated drive signal VOUT in the cycle Ta by switching whether or not to select the trapezoidal waveforms Adp, Bdp, and Cdp included in the drive signal COM in each of the periods T1, T2, and T3. The drive signal selection circuit 200 includes, as illustrated in FIG. 4, a selection control circuit 210 and a plurality of selection circuits 230.

The clock signal SCK, the printing data signal SI, the latch signal LAT, the change signal CH, and the voltage VHV_H are supplied to the selection control circuit 210. In the selection control circuit 210, a set of a shift register 212 (S/R), a latch circuit 214, and a decoder 216 is provided to correspond to each of the discharge sections 600. That is, the head unit 20 is provided with the same number of sets of the shift register 212, the latch circuit 214, and the decoder 216 as a total number n of the discharge sections 600.

The shift register 212 temporarily holds 2-bit printing data [SIH, SIL] included in the printing data signal SI for each corresponding discharge section 600. Specifically, the shift registers 212 having the number of stages corresponding to the discharge sections 600 are cascade-coupled to each other, and the serially supplied printing data signal SI is sequentially transferred to the subsequent stage in accordance with the clock signal SCK. In FIG. 4, in order to distinguish the shift registers 212, a first stage, a second stage, . . . , and an n-th stage are described in order from an upstream part to which the printing data signal SI is supplied.

Each of the n latch circuits 214 latches the printing data [SIH, SIL] held by the corresponding shift register 212 at the rising edge of the latch signal LAT. Each of the n decoders 216 decodes the 2-bit printing data [SIH, SIL] latched by the corresponding latch circuit 214 to generate a selection signal S, and supplies the generated selection signal to the selection circuit 230.

The selection circuit 230 is provided corresponding to each of the discharge sections 600. That is, the number of selection circuits 230 included in one head unit 20 is the same as the total number n of the discharge sections 600 included in the head unit 20. The selection circuit 230 controls the supply of the drive signal COM to the piezoelectric element 60 based on the selection signal S supplied from the decoder 216.

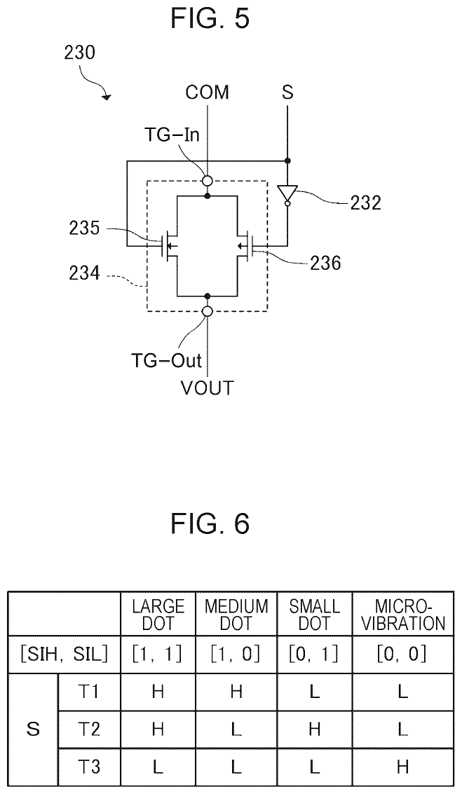

FIG. 5 is a circuit diagram illustrating an electrical configuration of the selection circuit 230 corresponding to one discharge section 600. The selection circuit 230 includes, as illustrated in FIG. 5, an inverter 232 and a transfer gate 234. In addition, the transfer gate 234 includes a transistor 235 that is an NMOS transistor, and a transistor 236 that is a PMOS transistor.

The selection signal S is supplied from the decoder 216 to a gate terminal of the transistor 235. Further, the selection signal S is logically inverted by the inverter 232 and is also supplied to a gate terminal of the transistor 236. A drain terminal of the transistor 235 and a source terminal of the transistor 236 are coupled to a terminal TG-In that is one end. The drive signal COM is input from the terminal TG-In. Then, the transistor 235 and the transistor 236 are controlled to be on or off in accordance with the selection signal S, and thus the drive signal VOUT is output from a terminal TG-Out that is the other end to which the source terminal of the transistor 235 and the drain terminal of the transistor 236 are commonly coupled. The terminal TG-Out is electrically coupled to an electrode 611, which will be described later, of the piezoelectric element 60. In the following description, a case where the transistor 235 and the transistor 236 are controlled to be in a conductive state may be referred to as on, and a case where the transistor 235 and the transistor 236 are controlled to be a non-conductive state may be referred to as off.

Next, the decoded contents of the decoder 216 will be described with reference to FIG. 6. FIG. 6 is a diagram illustrating the decoded contents in the decoder 216. The 2-bit printing data [SIH, SIL], the latch signal LAT, and the change signal CH are input to the decoder 216. Then, for example, when the printing data [SIH, SIL] is [1, 0] that defines a “medium dot”, the decoder 216 outputs the selection signal S that is at an H level, an L level, and an L level in the periods T1, T2, and T3. Here, a logic level of the selection signal S is level-shifted to a high-amplitude logic based on the voltage VHV_H by a level shifter (not illustrated).

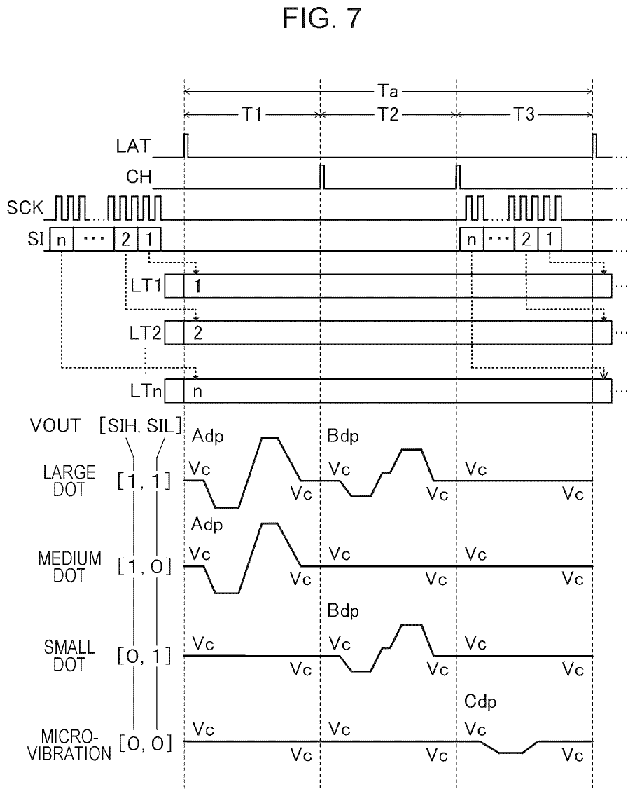

FIG. 7 is a diagram illustrating the operation of the drive signal selection circuit 200. As illustrated in FIG. 7, the printing data signal SI is serially supplied to the drive signal selection circuit 200 in synchronization with the clock signal SCK, and is sequentially transferred in the shift register 212 corresponding to the discharge section 600. Then, when the supply of the clock signal SCK is stopped, the printing data [SIH, SIL] corresponding to the discharge section 600 is held in each of the shift registers 212. The printing data signal SI is supplied in an order corresponding to the discharge sections 600 on the last n-th stage, . . . , the second stage, and the first stage in the shift register 212.

Here, when the latch signal LAT rises, each of the latch circuits 214 simultaneously latches the printing data [SIH, SIL] held in the corresponding shift register 212. LT1, LT2, . . . , and LTn illustrated in FIG. 7 are the printing data [SIH, SIL] latched by the latch circuits 214 corresponding to the shift registers 212 of the first stage, the second stage, . . . , and the n-th stage.

The decoder 216 outputs the selection signal S having a logic level in accordance with the contents illustrated in FIG. 6, in each of the periods T1, T2, and T3, in accordance with a dot size defined by the latched printing data [SIH, SIL].

When the printing data [SIH, SIL] is [1, 1], the selection circuit 230 selects the trapezoidal waveform Adp in the period T1, selects the trapezoidal waveform Bdp in the period T2, and does not select the trapezoidal waveform Cdp in the period T3, in accordance with the selection signal S. As a result, the drive signal VOUT corresponding to a large dot illustrated in FIG. 7 is generated. Therefore, a medium amount of ink and a small amount of ink are discharged from the discharge section 600. Therefore, the inks combine to form the large dot on the medium P. When the printing data [SIH, SIL] is [1, 0], the selection circuit 230 selects the trapezoidal waveform Adp in the period T1, does not select the trapezoidal waveform Bdp in the period T2, and does not select the trapezoidal waveform Cdp in the period T3, in accordance with the selection signal S. As a result, the drive signal VOUT corresponding to a medium dot illustrated in FIG. 7 is generated. Therefore, a medium amount of ink is discharged from the discharge section 600. Therefore, the medium dot is formed on the medium P. Further, when the printing data [SIH, SIL] is [0, 1], the selection circuit 230 does not select the trapezoidal waveform Adp in the period T1, selects the trapezoidal waveform Bdp in the period T2, and does not select the trapezoidal waveform Cdp in the period T3, in accordance with the selection signal S. As a result, the drive signal VOUT corresponding to a small dot illustrated in FIG. 7 is generated. Thus, a small amount of ink is discharged from the discharge section 600. Therefore, the small dot is formed on the medium P. Further, when the printing data [SIH, SIL] is [0, 0], the selection circuit 230 does not select the trapezoidal waveform Adp in the period T1, does not select the trapezoidal waveform Bdp in the period T2, and selects the trapezoidal waveform Cdp in the period T3, in accordance with the selection signal S. As a result, the drive signal VOUT corresponding to the micro-vibration illustrated in FIG. 7 is generated. Therefore, the ink is not discharged from the discharge section 600, and the micro-vibration occurs.

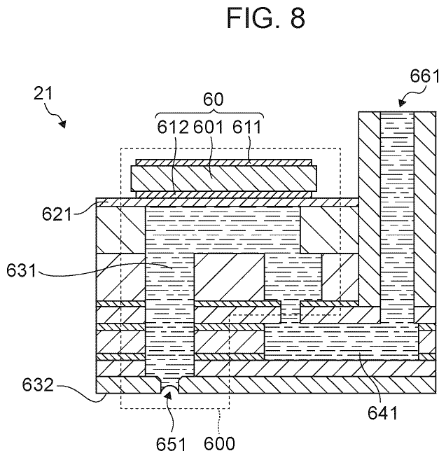

Here, a configuration and an operation of the discharge section 600 including the piezoelectric element 60 will be described with reference to FIG. 8. FIG. 8 is a cross-sectional view illustrating a schematic configuration of the discharge section 600 when the liquid discharge module 21 is cut such that the discharge section 600 is included.

As illustrated in FIG. 8, the liquid discharge module 21 includes a discharge section 600 and a reservoir 641. The ink is introduced into the reservoir 641 from a supply port 661. The reservoir 641 is provided for each color of the ink.

The discharge section 600 includes the piezoelectric element 60, a vibration plate 621, a cavity 631, and a nozzle 651. The vibration plate 621 is provided between the cavity 631 and the piezoelectric element 60. Then, the vibration plate 621 is displaced by driving the piezoelectric element 60 provided on an upper surface thereof. That is, the vibration plate 621 functions as a diaphragm that expands and reduces an internal volume of the cavity 631 by being displaced. The inside of the cavity 631 is filled with the ink. In addition, the cavity 631 functions as a pressure chamber in which the internal volume changes by driving the piezoelectric element 60. The nozzle 651 is an opening portion that is provided on a nozzle plate 632 and communicates with the cavity 631.

The piezoelectric element 60 has a structure in which a piezoelectric body 601 is sandwiched between a pair of electrodes 611 and 612. The electrode 611 is supplied with the drive signal VOUT, and the electrode 612 is supplied with the reference voltage signal VBS. The piezoelectric element 60 having the structure is driven in accordance with a potential difference between the electrode 611 and the electrode 612. As the piezoelectric element 60 is driven, the electrodes 611 and 612 and a central portion of the vibration plate 621 are displaced in an up-down direction with respect to both end portions. Then, the internal volume of the cavity 631 changes with the displacement of the vibration plate 621, and the ink that fills the inside of the cavity 631 is discharged from the nozzle 651.

Here, as described above, the drive signal VOUTa is a signal in which at least a part of the waveform of the drive signal COMa is selected, the piezoelectric element 60a is driven by the drive signal COMa, and the discharge section 600a discharges the ink onto the medium P in response to the driving of the piezoelectric element 60a. Similarly, the drive signal VOUTb is a signal in which at least a part of the waveform of the drive signal COMb is selected, the piezoelectric element 60b is driven by the drive signal COMb, and the discharge section 600b discharges the ink onto the medium P in response to the driving of the piezoelectric element 60b. Similarly, the drive signal VOUTc is a signal in which at least a part of the waveform of the drive signal COMc is selected, the piezoelectric element 60c is driven by the drive signal COMc, and the discharge section 600c discharges the ink onto the medium P in response to the driving of the piezoelectric element 60c. Similarly, the drive signal VOUTd is a signal in which at least a part of the waveform of the drive signal COMd is selected, the piezoelectric element 60d is driven by the drive signal COMd, and the discharge section 600d discharges the ink onto the medium P in response to the driving of the piezoelectric element 60d.

### 1-4. Circuit Configuration and Operation of Drive Circuit Substrate

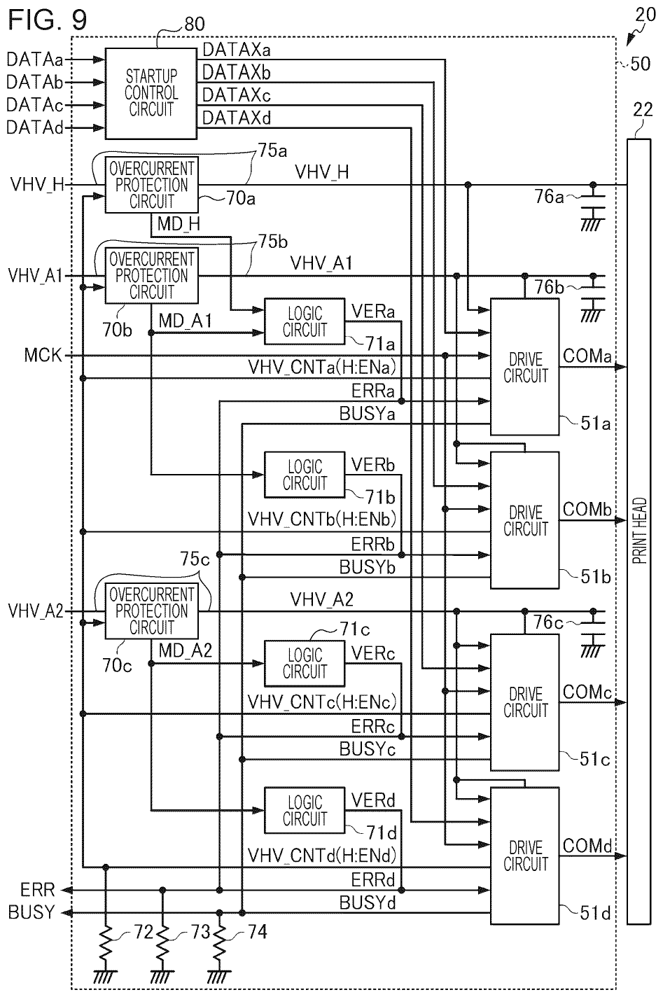

Next, the circuit configuration and the operation of the drive circuit substrate 50 will be described. FIG. 9 is a block diagram illustrating the circuit configuration of the drive circuit substrate 50. The drive circuit substrate 50 includes, as illustrated in FIG. 9, overcurrent protection circuits 70a, 70b, and 70c, logic circuits 71a, 71b, 71c, and 71d, resistors 72, 73, and 74, power supply wirings 75a, 75b, and 75c, capacitors 76a, 76b, and 76c, and a startup control circuit 80.

The power supply wiring 75a is a wiring that couples the power supply circuit 90 and the print head 22 illustrated in FIG. 2, and the voltage VHV_H is supplied to the print head 22 through the power supply wiring 75a. The power supply wiring 75b is a wiring that couples the power supply circuit 90 and the drive circuits 51a and 51b, and the voltage VHV_A1 is supplied to the drive circuits 51a and 51b through the power supply wiring 75b. The power supply wiring 75c is a wiring that couples the power supply circuit 90 and the drive circuits 51c and 51d, and the voltage VHV_A1 is supplied to the drive circuits 51c and 51d through the power supply wiring 75c.

In the present embodiment, the voltage VHV_A1, which is supplied to the drive circuits 51a and 51b, is a different signal from the voltage VHV_H supplied to the print head 22, and is not supplied to the print head 22. Similarly, the voltage VHV_A2, which is supplied to the drive circuits 51c and 51d, is a different signal from the voltage VHV_H supplied to the print head 22, and is not supplied to the print head 22.

The capacitor 76a is coupled between the power supply wiring 75a and a ground. The capacitor 76b is coupled between the power supply wiring 75b and the ground. The capacitor 76c is coupled between the power supply wiring 75c and the ground. The capacitors 76a, 76b, and 76c are capacitors for stabilization. Since the drive circuits 51a, 51b, 51c, and 51d need to simultaneously charge and discharge a large number of piezoelectric elements 60, a capacitance value of the capacitor 76b coupled to the power supply wiring 75b through which the power supply voltage VHV_A1 of the drive circuits 51a and 51b propagates or a capacitance value of the capacitor 76c coupled to the power supply wiring 75c through which the power supply voltage VHV_A2 of the drive circuits 51c and 51d propagates is higher than a capacitance value of the capacitor 76a coupled to the power supply wiring 75a through which the power supply voltage VHV_H of the print head 22 propagates.

The overcurrent protection circuit 70a is provided on the power supply wiring 75a, and has a conduction mode that puts the power supply circuit 90 and the print head 22 in a conductive state and a non-conduction mode that puts the power supply circuit 90 and the print head 22 in a non-conductive state. Then, the overcurrent protection circuit 70a outputs an operation mode signal MD_H indicating whether an operation mode is the conduction mode or the non-conduction mode. In the present embodiment, the operation mode is the conduction mode when the operation mode signal MD_H is at the H level, and the operation mode is the non-conduction mode when the operation mode signal MD_H is at the L level.

When the current flowing through the power supply wiring 75a in the conduction mode is equal to or higher than a predetermined value, the overcurrent protection circuit 70a switches from the conduction mode to the non-conduction mode. When the current flowing through the power supply wiring 75a is equal to or higher than the predetermined value, the overcurrent protection circuit 70a switches from the conduction mode to the non-conduction mode, so that the supply of the voltage VHV_H from the power supply circuit 90 to the print head 22 is stopped, and the operation mode signal MD_H changes from the H level to the L level.

Further, the overcurrent protection circuit 70a may also switch from the conduction mode to the non-conduction mode when the voltage VHV_H output from the power supply circuit 90 in the conduction mode is equal to or lower than a predetermined value. When the voltage VHV_H is equal to or lower than the predetermined value, the overcurrent protection circuit 70a switches from the conduction mode to the non-conduction mode, so that the supply of the voltage VHV_H from the power supply circuit 90 to the print head 22 is stopped, and the operation mode signal MD_H changes from the H level to the L level.

The overcurrent protection circuit 70b is provided on the power supply wiring 75b, and has a conduction mode that puts the power supply circuit 90 and the drive circuits 51a and 51b in a conductive state and a non-conduction mode that puts the power supply circuit 90 and the drive circuits 51a and 51b in a non-conductive state. Then, the overcurrent protection circuit 70b outputs an operation mode signal MD_A1 indicating whether the operation mode is the conduction mode or the non-conduction mode. In the present embodiment, the operation mode is the conduction mode when the operation mode signal MD_A1 is at the H level, and the operation mode is the non-conduction mode when the operation mode signal MD_A1 is at the L level.

When the current flowing through the power supply wiring 75b in the conduction mode is equal to or higher than a predetermined value, the overcurrent protection circuit 70b switches from the conduction mode to the non-conduction mode. When the current flowing through the power supply wiring 75b is equal to or higher than a predetermined value, the overcurrent protection circuit 70b switches from the conduction mode to the non-conduction mode, so that the supply of the voltage VHV_A1 from the power supply circuit 90 to the drive circuits 51a and 51b is stopped, and the operation mode signal MD_A1 changes from the H level to the L level.

Further, the overcurrent protection circuit 70b may also switch from the conduction mode to the non-conduction mode when the voltage VHV_A1 output from the power supply circuit 90 in the conduction mode is equal to or lower than a predetermined value. When the voltage VHV_A1 is equal to or lower than the predetermined value, the overcurrent protection circuit 70b switches from the conduction mode to the non-conduction mode, so that the supply of the voltage VHV_A1 from the power supply circuit 90 to the drive circuits 51a and 51b is stopped, and the operation mode signal MD_A1 changes from the H level to the L level.

The logic circuit 71a receives the operation mode signal MD_H and the operation mode signal MD_A1, and outputs a VHV abnormality signal VERa. Specifically, the logic circuit 71a outputs the VHV abnormality signal VERa at the L level indicating that both the voltage VHV_H and the voltage VHV_A1 are normal when the operation mode signal MD_H and the operation mode signal MD_A1 are at the H level, and outputs the VHV abnormality signal VERa at the H level indicating that at least one of the voltage VHV_H and the voltage VHV_A1 is abnormal when at least one of the operation mode signal MD_H and the operation mode signal MD_A1 is at the L level. That is, the logic circuit 71a is achieved by a 2-input NAND circuit. The VHV abnormality signal VERa output from the logic circuit 71a is input to the drive circuit 51a, as an error signal ERRa.

The drive circuit 51a stops outputting a drive waveform of the drive signal COMa when the error signal ERRa is at the H level. Further, the drive circuit 51a outputs an enable signal ENa to the overcurrent protection circuits 70a and 70b when the error signal ERRa is at the L level, and stops outputting the enable signal ENa to the overcurrent protection circuits 70a and 70b when the error signal ERRa is at the H level. Therefore, when the overcurrent protection circuit 70a switches from the conduction mode to the non-conduction mode, the drive circuit 51a stops outputting the enable signal ENa to the overcurrent protection circuit 70a, and stops outputting the enable signal ENa to the overcurrent protection circuit 70b. Further, when the overcurrent protection circuit 70b switches from the conduction mode to the non-conduction mode, the drive circuit 51a stops outputting the enable signal ENa to the overcurrent protection circuit 70b, and stops outputting the enable signal ENa to the overcurrent protection circuit 70a.

In the present embodiment, the enable signal ENa is a control signal VHV_CNTa at the H level output from the drive circuit 51a, and the drive circuit 51a stops outputting the enable signal ENa by outputting the control signal VHV_CNTa at the L level. The overcurrent protection circuits 70a and 70b are in the conduction mode or the non-conduction mode in accordance with the currents flowing through the power supply wirings 75a and 75b, when the enable signal ENa is input, and are in the non-conduction mode when the enable signal ENa is not input. Therefore, the overcurrent protection circuit 70b also switches from the conduction mode to the non-conduction mode when the output of the enable signal ENa from the drive circuit 51a is stopped due to the overcurrent protection circuit 70a that switches from the conduction mode to the non-conduction mode. Similarly, the overcurrent protection circuit 70a also switches from the conduction mode to the non-conduction mode when the output of the enable signal ENa from the drive circuit 51a is stopped due to the overcurrent protection circuit 70b that switches from the conduction mode to the non-conduction mode. When the enable signal ENa is not input, the overcurrent protection circuits 70a and 70b are not in the conduction mode even when the currents flowing through the power supply wirings 75a and 75b are lower than the predetermined value.

Further, the overcurrent protection circuit 70a can switch from the non-conduction mode to the conduction mode. Specifically, the overcurrent protection circuit 70a switches from the non-conduction mode to the conduction mode in response to the input of a predetermined signal. The predetermined signal may be, for example, the enable signal ENa output from the drive circuit 51a. That is, the overcurrent protection circuit 70a may switch from the non-conduction mode to the conduction mode by switching the control signal VHV_CNTa output from the drive circuit 51a from the L level to the H level. Alternatively, the drive circuit 51a may continue to output the control signal VHV_CNTa at the L level until reset, after switching the control signal VHV_CNTa from the H level to the L level, and switch the control signal VHV_CNTa from the L level to the H level when reset. In such a case, the predetermined signal is a reset signal (not illustrated).

The logic circuit 71b receives the operation mode signal MD_A1, and outputs a VHV abnormality signal VERb. Specifically, the logic circuit 71b outputs the VHV abnormality signal VERa at the L level indicating that the voltage VHV_A1 is normal when the operation mode signal MD_A1 is at the H level, and outputs the VHV abnormality signal VERb at the H level indicating that the voltage VHV_A1 is abnormal when the operation mode signal MD_A1 is at the L level. That is, the logic circuit 71b is achieved by a NOT circuit. The VHV abnormality signal VERb output from the logic circuit 71b is input to the drive circuit 51b, as an error signal ERRb.

The drive circuit 51b stops outputting a drive waveform of the drive signal COMb when the error signal ERRb is at the H level. Further, the drive circuit 51b outputs an enable signal ENb to the overcurrent protection circuit 70b when the error signal ERRb is at the L level, and stops outputting the enable signal ENb to the overcurrent protection circuit 70b when the error signal ERRb is at the H level. Therefore, when the overcurrent protection circuit 70b switches from the conduction mode to the non-conduction mode, the drive circuit 51b stops outputting the enable signal ENb to the overcurrent protection circuit 70b.

In the present embodiment, the enable signal ENb is a control signal VHV_CNTb at the H level output from the drive circuit 51b, and the drive circuit 51b stops outputting the enable signal ENb by outputting the control signal VHV_CNTb at the L level. The overcurrent protection circuit 70b is in the conduction mode or the non-conduction mode in accordance with the current flowing through the power supply wiring 75b when the enable signal ENb is input, and is in the non-conduction mode when the enable signal ENb is not input. When the enable signal ENb is not input, the overcurrent protection circuit 70b is not in the conduction mode even when the current flowing through the power supply wiring 75b is lower than the predetermined value.

Further, the overcurrent protection circuit 70b can switch from the non-conduction mode to the conduction mode. Specifically, the overcurrent protection circuit 70b switches from the non-conduction mode to the conduction mode in response to the input of a predetermined signal. The predetermined signal may be, for example, the enable signals ENa and ENb output from the drive circuits 51a and 51b. That is, the overcurrent protection circuit 70b may switch from the non-conduction mode to the conduction mode when both the control signals VHV_CNTa and VHV_CNTb output from the drive circuits 51a and 51b are at the H level. Alternatively, the drive circuits 51a and 51b may continue to output the control signals VHV_CNTa and VHV_CNTb at the L level until reset, after switching the control signals VHV_CNTa and VHV_CNTb from the H level to the L level, and switch the control signals VHV_CNTa and VHV_CNTb from the L level to the H level when reset. In such a case, the predetermined signal is a reset signal (not illustrated).

The overcurrent protection circuit 70c is provided on the power supply wiring 75c, and has a conduction mode that puts the power supply circuit 90 and the drive circuits 51c and 51d in a conductive state and a non-conduction mode that puts the power supply circuit 90 and the drive circuits 51c and 51d in a non-conductive state. Then, the overcurrent protection circuit 70c outputs an operation mode signal MD_A2 indicating whether the operation mode is the conduction mode or the non-conduction mode. In the present embodiment, the operation mode is the conduction mode when the operation mode signal MD_A2 is at the H level, and the operation mode is the non-conduction mode when the operation mode signal MD_A2 is at the L level.

When the current flowing through the power supply wiring 75c in the conduction mode is equal to or higher than a predetermined value, the overcurrent protection circuit 70c switches from the conduction mode to the non-conduction mode. When the current flowing through the power supply wiring 75c is equal to or higher than a predetermined value, the overcurrent protection circuit 70c switches from the conduction mode to the non-conduction mode, so that the supply of the voltage VHV_A2 from the power supply circuit 90 to the drive circuits 51c and 51d is stopped, and the operation mode signal MD_A2 changes from the H level to the L level.

Further, the overcurrent protection circuit 70c may also switch from the conduction mode to the non-conduction mode when the voltage VHV_A2 output from the power supply circuit 90 in the conduction mode is equal to or lower than a predetermined value. When the voltage VHV_A2 is equal to or lower than the predetermined value, the overcurrent protection circuit 70c switches from the conduction mode to the non-conduction mode, so that the supply of the voltage VHV_A2 from the power supply circuit 90 to the drive circuits 51c and 51d is stopped, and the operation mode signal MD_A2 changes from the H level to the L level.

The logic circuit 71c receives the operation mode signal MD_A2, and outputs a VHV abnormality signal VERc. Specifically, the logic circuit 71c outputs the VHV abnormality signal VERc at the L level indicating that the voltage VHV_A2 is normal when the operation mode signal MD_A2 is at the H level, and outputs the VHV abnormality signal VERc at the H level indicating that the voltage VHV_A2 is abnormal when the operation mode signal MD_A2 is at the L level. That is, the logic circuit 71c is achieved by a NOT circuit. The VHV abnormality signal VERc output from the logic circuit 71c is input to the drive circuit 51c, as an error signal ERRc.

The drive circuit 51c stops outputting a drive waveform of the drive signal COMc when the error signal ERRc is at the H level. Further, the drive circuit 51c outputs an enable signal ENc to the overcurrent protection circuit 70c when the error signal ERRc is at the L level, and stops outputting the enable signal ENc to the overcurrent protection circuit 70c when the error signal ERRc is at the H level. Therefore, the drive circuit 51c stops outputting the enable signal ENc to the overcurrent protection circuit 70c when the overcurrent protection circuit 70c switches from the conduction mode to the non-conduction mode.

In the present embodiment, the enable signal ENc is a control signal VHV_CNTc at the H level output from the drive circuit 51c, and the drive circuit 51c stops outputting the enable signal ENc by outputting the control signal VHV_CNTc at the L level. The overcurrent protection circuit 70c is in the conduction mode or the non-conduction mode in accordance with the current flowing through the power supply wiring 75c when the enable signal ENc is input, and is in the non-conduction mode when the enable signal ENc is not input. When the enable signal ENc is not input, the overcurrent protection circuit 70c is not in the conduction mode even when the current flowing through the power supply wiring 75c is lower than the predetermined value.

The logic circuit 71d receives the operation mode signal MD_A2, and outputs a VHV abnormality signal VERd. Specifically, the logic circuit 71d outputs the VHV abnormality signal VERd at the L level indicating that the voltage VHV_A2 is normal when the operation mode signal MD_A2 is at the H level, and outputs the VHV abnormality signal VERd at the H level indicating that the voltage VHV_A2 is abnormal when the operation mode signal MD_A2 is at the L level. That is, the logic circuit 71d is achieved by a NOT circuit. The VHV abnormality signal VERd output from the logic circuit 71d is input to the drive circuit 51d, as an error signal ERRd.

The drive circuit 51d stops outputting a drive waveform of the drive signal COMd when the error signal ERRd is at the H level. Further, the drive circuit 51d outputs an enable signal ENd to the overcurrent protection circuit 70c when the error signal ERRd is at the L level, and stops outputting the enable signal ENd to the overcurrent protection circuit 70c when the error signal ERRd is at the H level. Therefore, when the overcurrent protection circuit 70c switches from the conduction mode to the non-conduction mode, the drive circuit 51d stops outputting the enable signal ENd to the overcurrent protection circuit 70c.

In the present embodiment, the enable signal ENd is a control signal VHV_CNTd at the H level output from the drive circuit 51d, and the drive circuit 51d stops outputting the enable signal ENd by outputting the control signal VHV_CNTd at the L level. The overcurrent protection circuit 70c is in the conduction mode or the non-conduction mode in accordance with the current flowing through the power supply wiring 75c when the enable signal ENd is input, and is in the non-conduction mode when the enable signal ENd is not input. When the enable signal ENd is not input, the overcurrent protection circuit 70c is not in the conduction mode even when the current flowing through the power supply wiring 75c is lower than the predetermined value.

Further, the overcurrent protection circuit 70c can switch from the non-conduction mode to the conduction mode. Specifically, the overcurrent protection circuit 70c switches from the non-conduction mode to the conduction mode in response to the input of a predetermined signal. The predetermined signal may be, for example, the enable signals ENc and ENd output from the drive circuits 51c and 51d. That is, the overcurrent protection circuit 70c may switch from the non-conduction mode to the conduction mode when both the control signal VHV_CNTc output from the drive circuit 51c and the control signal VHV_CNTd output from the drive circuit 51d are at the H level. Alternatively, the drive circuits 51c and 51d may continue to output the control signals VHV_CNTc and VHV_CNTd at the L level until reset, after switching the control signals VHV_CNTc and VHV_CNTd from the H level to the L level, and switch the control signals VHV_CNTc and VHV_CNTd from the L level to the H level when reset. In such a case, the predetermined signal is a reset signal (not illustrated).

As illustrated in FIG. 9, in practice, the terminals of the drive circuits 51a, 51b, 51c, and 51d, which output the control signals VHV_CNTa, VHV_CNTb, VHV_CNTc, and VHV_CNTd, respectively, are electrically coupled to each other. Then, the drive circuits 51a, 51b, 51c, and 51d set each terminal to high impedance (Hi-Z) instead of outputting the control signals VHV_CNTa, VHV_CNTb, VHV_CNTc, and VHV_CNTd at the L level, and the control signals VHV_CNTa, VHV_CNTb, VHV_CNTC, and VHV_CNTd are at the L level by a pull-down resistor 72. Further, when at least one of the control signals VHV_CNTa, VHV_CNTb, VHV_CNTc, and VHV_CNTd is at the H level, a common enable signal is input to the overcurrent protection circuits 70a, 70b, and 70c. On the other hand, when all the control signals VHV_CNTa, VHV_CNTb, VHV_CNTc, and VHV_CNTd are at the L level, the input of the enable signals to the overcurrent protection circuits 70a, 70b, and 70c is stopped.

Since the overcurrent protection circuits 70a, 70b, and 70c have the same configuration, the overcurrent protection circuits 70a, 70b, and 70c are referred to as an overcurrent protection circuit 70, and the configuration example of the overcurrent protection circuit 70 will be described. In addition, in the description of the configuration example of the overcurrent protection circuit 70, the voltages VHV_H, VHV_A1, and VHV_A2 are referred to as a voltage VHV, the operation mode signals MD_H, MD_A1, and MD_A2 are referred to as an operation mode signal MD, and the control signals VHV_CNTa, VHV_CNTb, VHV_CNTc, and VHV_CNTd are referred to as a control signal VHV_CNT.

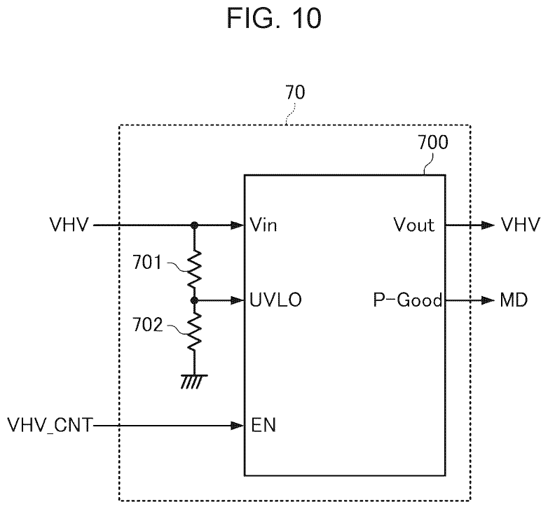

FIG. 10 is a diagram illustrating the configuration example of the overcurrent protection circuit 70. The overcurrent protection circuit 70 includes, as illustrated in FIG. 10, an electronic fuse IC 700 and resistors 701 and 702. The electronic fuse IC 700 includes a Vin terminal, a Vout terminal, a UVLO terminal, a P-Good terminal, and an EN terminal. The Vin terminal is a voltage input terminal, and the Vout terminal is a voltage output terminal. The UVLO terminal is a terminal for detecting a decrease in the input voltage, and the P-Good terminal is an output terminal indicating a state of the input voltage. The EN terminal is an enable terminal.

The electronic fuse IC 700 operates when the EN terminal is at the L level and when the control signal VHV_CNT is at the H level. When the current flowing to the Vin terminal is equal to or higher than a predetermined value, the electronic fuse IC 700 makes the Vin terminal and the Vout terminal non-conductive, and outputs an L-level signal from the P-Good terminal. Further, when the voltage input to the UVLO terminal is equal to or lower than a predetermined value, the electronic fuse IC 700 makes the Vin terminal and the Vout terminal non-conductive, and outputs an L-level signal from the P-Good terminal. In addition, when the current flowing to the Vin terminal is lower than the predetermined value and the voltage input to the UVLO terminal is higher than the predetermined value, the electronic fuse IC 700 makes the Vin terminal and the Vout terminal conductive, and outputs an H-level signal from the P-Good terminal.

The control signal VHV_CNT is input to the EN terminal. The Vin terminal is coupled to the power supply circuit 90 through the power supply wiring, and the Vout terminal is coupled to the print head 22 or the drive circuit 51 through the power supply wiring. The voltage VHV is input to the Vin terminal. The resistors 701 and 702 are coupled in series between the Vin terminal and the ground, and a coupling node between the resistor 701 and the resistor 702 is coupled to the UVLO terminal. Therefore, a voltage obtained by dividing the voltage VHV via the resistors 701 and 702 is input to the UVLO terminal. The above-described functions are achieved by the overcurrent protection circuit 70 configured as described above.

Returning to the description of FIG. 9, the drive circuit 51a monitors the voltage VHV_H supplied to the print head 22 through the power supply wiring 75a. Then, the drive circuit 51a outputs the error signal ERRa at the L level when the voltage VHV_H is higher than a predetermined voltage, and outputs the error signal ERRa at the H level and stops outputting the drive waveform of the drive signal COMa when the voltage VHV_H is equal to or lower than the predetermined voltage. In addition, the error signal ERRa at the H level is a signal for stopping the output of the voltage VHV_H from the power supply circuit 90, and the power supply circuit 90 stops outputting the voltage VHV_H when the error signal ERRa is at the H level. For example, when the overcurrent protection circuit 70a switches from the conduction mode to the non-conduction mode, the voltage VHV_H monitored by the drive circuit 51a is equal to or lower than the predetermined voltage, and thus the drive circuit 51a outputs the error signal ERRa at the H level. When the voltage VHV_H is equal to or lower than the predetermined voltage, the drive circuit 51a may output the error signal ERRa at the H level and output the control signal VHV_CNTa at the L level.

In addition, the drive circuit 51b monitors the voltage VHV_A1 supplied to the drive circuits 51a and 51b through the power supply wiring 75b. Then, the drive circuit 51b outputs the error signal ERRb at the L level when the voltage VHV_A1 is higher than a predetermined voltage, and outputs the error signal ERRb at the H level and stops outputting the drive waveform of the drive signal COMb when the voltage VHV_A1 is equal to or lower than the predetermined voltage. In addition, the error signal ERRb at the H level is a signal for stopping the output of the voltage VHV_A1 from the power supply circuit 90, and the power supply circuit 90 stops outputting the voltage VHV_A1 when the error signal ERRb is at the H level. For example, when the overcurrent protection circuit 70b switches from the conduction mode to the non-conduction mode, the voltage VHV_A1 monitored by the drive circuit 51b is equal to or lower than the predetermined voltage, and thus the drive circuit 51b outputs the error signal ERRb at the H level. When the voltage VHV_A1 is equal to or lower than the predetermined voltage, the drive circuit 51b may output the error signal ERRb at the H level and output the control signal VHV_CNTb at the L level.

In addition, the drive circuit 51c monitors the voltage VHV_A2 supplied to the drive circuits 51c and 51d through the power supply wiring 75c. Then, the drive circuit 51c outputs the error signal ERRc at the L level when the voltage VHV_A2 is higher than a predetermined voltage, and outputs the error signal ERRc at the H level and stops outputting the drive waveform of the drive signal COMc when the voltage VHV_A2 is equal to or lower than the predetermined voltage. Similarly, the drive circuit 51d monitors the voltage VHV_A2 supplied to the drive circuits 51c and 51d through the power supply wiring 75c. Then, the drive circuit 51d outputs the error signal ERRd at the L level when the voltage VHV_A2 is higher than the predetermined voltage, and outputs the error signal ERRd at the H level and stops outputting the drive waveform of the drive signal COMd when the voltage VHV_A2 is equal to or lower than the predetermined voltage. Further, the error signals ERRc and ERRd at the H level are signals for stopping the output of the voltage VHV_A2 from the power supply circuit 90, and the power supply circuit 90 stops outputting the voltage VHV_A2 when at least one of the error signals ERRc and ERRd is at the H level. For example, when the overcurrent protection circuit 70c switches from the conduction mode to the non-conduction mode, the voltage VHV_A2 monitored by the drive circuits 51c and 51d is equal to or lower than the predetermined voltage, and thus the drive circuits 51c and 51d output the error signals ERRc and ERRd at the H level, respectively. When the voltage VHV_A2 is equal to or lower than the predetermined voltage, the drive circuits 51c and 51d may output the error signals ERRc and ERRd, respectively, at the H level and output the control signals VHV_CNTc and VHV_CNTd, respectively, at the L level.

As illustrated in FIG. 9, in practice, the terminals of the drive circuits 51a, 51b, 51c, and 51d, which output the error signals ERRa, ERRb, ERRc, and ERRd, respectively, are electrically coupled to each other. Then, the drive circuits 51a, 51b, 51c, and 51d set each terminal to Hi-Z instead of outputting the error signals ERRa, ERRb, ERRc, and ERRd at the L level, and the error signals ERRa, ERRb, ERRc, and ERRd are at the L level by a pull-down resistor 73. Further, when all the error signals ERRa, ERRb, ERRc, and ERRd are at the L level, the error signal input to the power supply circuit 90 is at the L level. On the other hand, when at least one of the error signals ERRa, ERRb, ERRc, and ERRd is at the H level, the error signal input to the power supply circuit 90 is at the H level, and the power supply circuit 90 stops outputting the voltages VHV_H, VHV_A1, and VHV_A2.

In addition, the terminal of the drive circuit 51a, which outputs the error signal ERRa, is also an input terminal, and, when the voltage of the terminal is switched from the L level to the H level, the drive circuit 51a stops outputting the drive waveform of the drive signal COMa and outputs the control signal VHV_CNTa at the L level. Similarly, the terminal of the drive circuit 51b, which outputs the error signal ERRb, is also an input terminal, and, when the voltage of the terminal is switched from the L level to the H level, the drive circuit 51b stops outputting the drive waveform of the drive signal COMb and outputs the control signal VHV_CNTb at the L level. Similarly, the terminal of the drive circuit 51c, which outputs the error signal ERRc, is also an input terminal, and, when the voltage of the terminal is switched from the L level to the H level, the drive circuit 51c stops outputting the drive waveform of the drive signal COMc and outputs the control signal VHV_CNTc at the L level. Similarly, the terminal of the drive circuit 51d, which outputs the error signal ERRd, is also an input terminal, and, when the voltage of the terminal is switched from the L level to the H level, the drive circuit 51d stops outputting the drive waveform of the drive signal COMd and outputs the control signal VHV_CNTd at the L level. Therefore, in a state in which all the error signals ERRa, ERRb, ERRc, and ERRd are at the L level, when at least one of the error signals ERRa, ERRb, ERRc, and ERRd is switched from the L level to the H level, the output of the drive waveforms of the drive signals COMa, COMb, COM, and COMd to the print head 22 is stopped, and all the control signals VHV_CNTa, VHV_CNTb, VHV_CNTc, and VHV_CNTd are at the L level. As a result, all the overcurrent protection circuits 70a, 70b, and 70c are in the non-conduction mode.

In addition, the drive circuit 51a outputs a state signal BUSYa indicating an operation state of the drive circuit 51a. Similarly, the drive circuit 51b outputs a state signal BUSYb indicating an operation state of the drive circuit 51b. Similarly, the drive circuit 51c outputs a state signal BUSYc indicating an operation state of the drive circuit 51c. Similarly, the drive circuit 51d outputs a state signal BUSYd indicating an operation state of the drive circuit 51d. The drive circuits 51a, 51b, 51c, and 51d output the state signals BUSYa, BUSY, BUSYc, and BUSYd at the H level, respectively, when the predetermined state is satisfied, and output the state signals BUSYa, BUSYb, BUSYC, and BUSYd at the L level, respectively, when the predetermined state is not satisfied. The state signals BUSYa, BUSYb, BUSYC, and BUSYd are output to the control circuit 100 of the control unit 10, and then the control circuit 100 determines the states of the drive circuits 51a, 51b, 51c, and 51d based on the state signals BUSYa, BUSYb, BUSYc, and BUSYd.

As illustrated in FIG. 9, in practice, the terminals of the drive circuits 51a, 51b, 51c, and 51d, which output the state signals BUSYa, BUSY, BUSYc, and BUSYd, respectively, are electrically coupled to each other. Then, the drive circuits 51a, 51b, 51c, and 51d set each terminal to Hi-Z instead of outputting the state signals BUSYa, BUSYb, BUSYC, and BUSYd at the L level, and the state signals BUSYa, BUSYb, BUSYc, and BUSYd are set to the L level by a pull-down resistor 74. Further, when all the state signals BUSYa, BUSYb, BUSYc, and BUSYd are at the L level, the state signal input to the control circuit 100 is at the L level. On the other hand, when at least one of the state signals BUSYa, BUSYb, BUSYC, and BUSYd is at the H level, the state signal input to the control circuit 100 is at the H level, and the control circuit 100 determines the state of the drive circuits 51a, 51b, 51c, and 51d based on the state signal.

Here, when the supply of the voltage VHV_H to the print head 22 is stopped or the voltage VHV_H decreases in a state in which the drive signals COMa, COMb, COMc, and COMd are supplied to the print head 22, there is a likelihood that an excessive current flows from each drive signal wiring to the power supply wiring due to the parasitic diode between each drive signal wiring through which the drive signals COMa, COMb, COMc, and COMd propagate and the power supply wiring through which the voltage VHV_H propagates inside the print head 22, to cause the failure of the print head 22.

When the drive circuit 51a is monitoring the voltage VHV_H, the drive circuit 51a outputs the error signal ERRa at the H level when the voltage VHV_H decreases, so that the output of the drive waveforms of the drive signals COMa, COMb, COMc, and COMd to the print head 22 is immediately stopped, and thus a probability that the print head 22 fails is low. On the other hand, when the voltage VHV_H decreases and at least one of the drive waveforms of the drive signals COMa, COMb, COMc, and COMd is output to the print head 22 before the drive circuit 51a starts monitoring the voltage VHV_H, there is a likelihood that the print head 22 fails. Therefore, in the present embodiment, the drive circuit substrate 50 includes the startup control circuit 80 that controls the startup of the drive circuits 51a, 51b, 51c, and 51d, and the startup control circuit 80 first starts up the drive circuit 51a that monitors the voltage VHV_H among the drive circuits 51a, 51b, 51c, and 51d when the head unit 20 is started up. That is, the startup control circuit 80 starts a startup sequence of the drive circuit 51a, and then starts startup sequences of the drive circuits 51b, 51c, and 51d.

In the present embodiment, the startup control circuit 80 receives the drive data signals DATAa, DATAb, DATAc, and DATAd output by the control circuit 100, and outputs data signals DATAXa, DATAXb, DATAXc, and DATAXd respectively corresponding to the drive data signals DATAa, DATAb, DATAc, and DATAd. That is, the startup control circuit 80 converts the drive data signals DATAa, DATAb, DATAc, and DATAd respectively into the data signals DATAXa, DATAXb, DATAXc, and DATAXd having formats corresponding to the input specifications of the drive circuits 51a, 51b, 51c, and 51d, and outputs the converted data signals DATAXa, DATAXb, DATAXC, and DATAXd. The data signals DATAXa, DATAXb, DATAXC, and DATAXd are respectively input to the drive circuits 51a, 51b, 51c, and 51d. As described above, the drive data signals DATAa, DATAb, DATAc, and DATAd are used to generate the drive signals COMa, COMb, COMc, and COMd, but, in practice, the drive circuits 51a, 51b, 51c, and 51d generate the drive signals COMa, COMb, COMc, and COMd based on the data signals DATAXa, DATAXb, DATAXc, and DATAXd, respectively.

In addition, the drive data signals DATAa, DATAB, DATAc, and DATAd are also used as commands for giving an instruction to start up the drive circuits 51a, 51b, 51c, and 51d. For example, the control circuit 100 may output the command for giving the instruction to start up the drive circuit 51a as the drive data signal DATAa, and output the commands for giving the instructions to start up the drive circuits 51b, 51c, and 51d as the drive data signals DATAB, DATAC, and DATAD after a predetermined time elapses. In such a case, when the control circuit 100 simply converts the formats of the drive data signals DATAa, DATAb, DATAc, and DATAd and outputs the data signals DATAXa, DATAXb, DATAXc, and DATAXd, the startup sequence of the drive circuit 51a is started before the startup sequences of the drive circuits 51b, 51c, and 51d. Alternatively, when at least one of the commands for giving the instructions to start up the drive circuits 51b, 51c, and 51d as the drive data signals DATAb, DATAc, and DATAd is input before the command for giving the instructions to start up the drive circuit 51a as the drive data signal DATAa is input, the control circuit 100 may place the output of the data signals DATAXb, DATAXc, and DATAXd on hold until the command for giving the instruction to start up the drive circuit 51a as the drive data signal DATAa is input and the data signal DATAXa is output. As a result, the startup sequence of the drive circuit 51a is started before the startup sequences of the drive circuits 51b, 51c, and 51d.

When the formats of the drive data signals DATAa, DATAb, DATAc, and DATAd match the input specifications of the drive circuits 51a, 51b, 51c, and 51d, the startup control circuit 80 may output the data signals DATAXa, DATAXb, DATAXC, and DATAXd without format conversion, the drive circuit substrate 50 may not include the startup control circuit 80, and the control circuit 100 may function as the startup control circuit 80.

### 1-5. Configuration of Drive Circuit

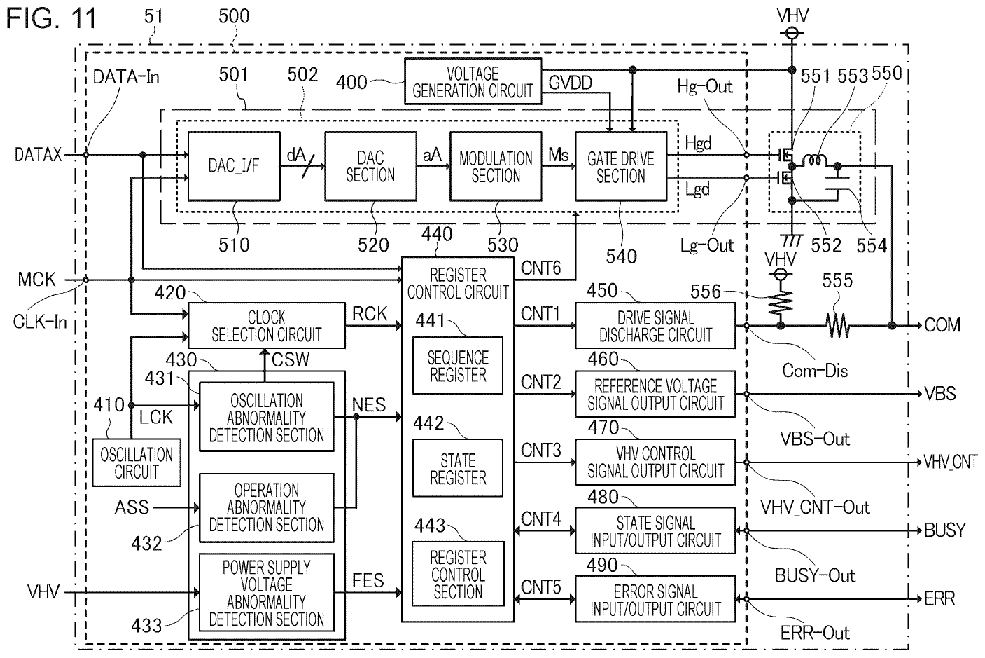

Next, configurations of the drive circuits 51a, 51b, 51c, and 51d will be described with reference to FIG. 11. In FIG. 11, the drive circuits 51a and 51b are referred to as a drive circuit 51 without distinguishing the drive circuits 51a and 51b. FIG. 11 is a block diagram illustrating the configuration of the drive circuit 51. The drive circuit 51 includes an integrated circuit 500, a drive signal amplification circuit 550, and resistors 555 and 556.

The integrated circuit 500 includes an amplification control signal generation circuit 502, a voltage generation circuit 400, an oscillation circuit 410, a clock selection circuit 420, an abnormality detection circuit 430, a register control circuit 440, a drive signal discharge circuit 450, a reference voltage signal output circuit 460, a VHV control signal output circuit 470, a state signal input/output circuit 480, and an error signal input/output circuit 490.

The voltage generation circuit 400 generates a voltage GVDD based on the voltage VHV. The voltage GVDD is, for example, a DC voltage signal of 7.5 V, and is input to various configurations of the integrated circuit 500 including a gate drive section 540 which will be described later.

The amplification control signal generation circuit 502 generates amplification control signals Hgd and Lgd based on a data signal that defines a waveform of the drive signal COM included in a drive data signal DATAX input from a terminal DATA-In. The amplification control signal generation circuit 502 includes a digital-to-analog converter interface (DAC interface: DAC I/F) 510, a DAC section 520, a modulation section 530, and a gate drive section 540.

The drive data signal DATAX supplied from the terminal DATA-In and a clock signal MCK supplied from a terminal MCK-In are input to the DAC interface 510. The DAC interface 510 integrates the drive data signal DATAX based on the clock signal MCK, and generates, for example, 10-bit drive data dA that defines a waveform of the drive signal COM. The drive data dA is input to the DAC section 520. The DAC section 520 converts the input drive data dA into a base drive signal aA that is an analog signal. The base drive signal aA is a target signal before the amplification of the drive signal COM. The base drive signal aA is input to the modulation section 530. The modulation section 530 outputs a modulated signal Ms obtained by performing pulse width modulation on the base drive signal aA. The voltages VHV and GVDD and the modulated signal Ms are input to the gate drive section 540. The gate drive section 540 amplifies the input modulated signal Ms based on the voltage GVDD and inverts the logic levels of the amplification control signal Hgd, which is level-shifted to a high amplitude logic level based on the voltage VHV, and the input modulated signal Ms, to generate the amplification control signal Lgd based on the voltage GVDD. That is, the amplification control signal Hgd and the amplification control signal Lgd are at the H level mutually exclusively. The amplification control signal Hgd is output from the integrated circuit 500 through a terminal Hg-Out, and is input to the drive signal amplification circuit 550. Similarly, the amplification control signal Lgd is output from the integrated circuit 500 through a terminal Lg-Out, and is input to the drive signal amplification circuit 550.

The drive signal amplification circuit 550 operates based on the amplification control signals Hgd and Lgd, to output the drive signal COM. The drive signal amplification circuit 550 includes transistors 551 and 552, a coil 553, and a capacitor 554. In addition, each of the transistors 551 and 552 is, for example, an N-channel field effect transistor (FET).

The voltage VHV is supplied to a drain terminal of the transistor 551. The amplification control signal Hgd is supplied to a gate terminal of the transistor 551 through the terminal Hg-Out. A source terminal of the transistor 551 is electrically coupled to a drain terminal of the transistor 552. The amplification control signal Lgd is supplied to a gate terminal of the transistor 552 through the terminal Lg-Out. A source electrode of the transistor 552 is coupled to the ground. The transistors 551, which is coupled as described above, operate in accordance with the amplification control signal Hgd, and the transistor 552 operates in accordance with the amplification control signal Lgd. That is, the transistor 551 and the transistor 552 are turned on mutually exclusively. As a result, an amplified modulated signal obtained by amplifying the modulated signal Ms based on the voltage VHV is generated at a coupling point between the source terminal of the transistor 551 and the drain terminal of the transistor 552.

One end of the coil 553 is commonly coupled to the source terminal of the transistor 551 and the drain terminal of the transistor 552. Further, the other end of the coil 553 is coupled to one end of the capacitor 554. The other end of the capacitor 554 is coupled to the ground. That is, the coil 553 and the capacitor 554 constitute a low-pass filter. Then, the amplified modulated signal is supplied to the low-pass filter, so that the amplified modulated signal is demodulated, and the drive signal COM is generated. Then, the drive circuit 51 outputs the drive signal COM generated as described above.

Here, in the following description, a configuration including the amplification control signal generation circuit 502, which is included in the integrated circuit 500, and the drive signal amplification circuit 550 may be referred to as a drive signal generation circuit 501 that generates the drive signal COM based on the drive data signal DATAX.

The oscillation circuit 410 generates a clock signal LCK that defines an operation timing of the integrated circuit 500, and outputs the generated clock signal LCK. The clock signal LCK is input to the clock selection circuit 420 and the abnormality detection circuit 430.

The clock signals MCK and LCK and a clock selection signal CSW are input to the clock selection circuit 420. The clock selection circuit 420 switches whether to output the clock signal MCK as a clock signal RCK to the register control circuit 440 or to output the clock signal LCK as the clock signal RCK to the register control circuit 440, based on the logic level of the clock selection signal CSW. In the present embodiment, the description will be made in which the clock selection circuit 420 outputs the clock signal MCK as the clock signal RCK to the register control circuit 440 when the clock selection signal CSW is at the H level, and outputs the clock signal LCK as the clock signal RCK to the register control circuit 440 when the clock selection signal CSW is at the L level.

The abnormality detection circuit 430 includes an oscillation abnormality detection section 431, an operation abnormality detection section 432, and a power supply voltage abnormality detection section 433.

The clock signal LCK, which is output from the oscillation circuit 410, is input to the oscillation abnormality detection section 431. The oscillation abnormality detection section 431 detects whether or not the input clock signal LCK is normal, and outputs the clock selection signal CSW and an error signal NES, which have the logic levels based on a detection result. For example, the oscillation abnormality detection section 431 detects at least one of a frequency and a voltage level of the clock signal LCK. Then, when at least one of the frequency and the voltage level of the clock signal LCK is abnormal, the oscillation abnormality detection section 431 outputs the clock selection signal CSW at the H level to the clock selection circuit 420, and outputs the error signal NES at the H level to the register control circuit 440. Further, when both the frequency and the voltage level of the clock signal LCK are normal, the oscillation abnormality detection section 431 outputs the clock selection signal CSW at the L level to the clock selection circuit 420, and outputs the error signal NES at the L level to the register control circuit 440.

An operation state signal ASS indicating each operation state of various configurations of the drive circuit 51 is input to the operation abnormality detection section 432. The operation abnormality detection section 432 detects whether or not various configurations of the drive circuit 51 normally operate, based on the logic level of the input operation state signal ASS. In the present embodiment, when any of the various configurations of the drive circuit 51 is abnormal, the operation state signal ASS at the H level is input to the operation abnormality detection section 432. When the operation state signal ASS at the H level is input, the operation abnormality detection section 432 outputs the error signal NES at the H level to the register control circuit 440.

The voltage VHV is input to the power supply voltage abnormality detection section 433. Then, the power supply voltage abnormality detection section 433 detects a voltage value of the voltage VHV. Then, the power supply voltage abnormality detection section 433 detects whether or not a voltage level of the voltage VHV supplied to the liquid discharge module 21 is normal, based on the voltage value of the voltage VHV. In the present embodiment, when it is determined that the voltage level of the voltage VHV supplied to the liquid discharge module 21 is abnormal, the power supply voltage abnormality detection section 433 outputs an error signal FES at the H level to the register control circuit 440.

The register control circuit 440 includes a sequence register 441, a state register 442, and a register control section 443. The sequence register 441 and the state register 442 hold operation information input as the drive data signal DATAX in synchronization with the clock signal MCK. Then, the register control section 443 generates control signals CNT1 to CNT6 based on the information held in the sequence register 441 and the state register 442 in synchronization with the clock signal RCK, and outputs the generated control signals CNT1 to CNT6. As a result, the operation of the drive circuit 51 is controlled.

The control signal CNT1 is input to the drive signal discharge circuit 450. The drive signal discharge circuit 450 controls the output of the drive signal COM output from the drive circuit 51. When the control signal CNT1 at the L level is input to the drive signal discharge circuit 450, the drive signal discharge circuit 450 releases the electric charges stored in a terminal Com-Dis. On the other hand, when the control signal CNT1 at the H level is input to the drive signal discharge circuit 450, the drive signal discharge circuit 450 does not release the electric charges stored in the terminal Com-Dis.

The control signal CNT2 is input to the reference voltage signal output circuit 460. The reference voltage signal output circuit 460 generates the reference voltage signal VBS supplied to the piezoelectric element 60, and outputs the generated reference voltage signal VBS. The reference voltage signal VBS is a signal with a constant voltage value based on the voltage GVDD. When the control signal CNT2 at the H level is input to the reference voltage signal output circuit 460, the reference voltage signal VBS with constant voltage value is output from a terminal VBS-Out. On the other hand, when the control signal CNT2 at the L level is input to the reference voltage signal output circuit 460, the reference voltage signal VBS of the ground potential is output. In other words, when the control signal CNT2 at the L level is input to the reference voltage signal output circuit 460, the output of the reference voltage signal VBS is stopped.

The control signal CNT3 is input to the VHV control signal output circuit 470. The VHV control signal output circuit 470 outputs the control signal VHV_CNT. When the control signal CNT3 at the L level is input to the VHV control signal output circuit 470, the voltage GVDD is supplied to a terminal VHV_CNT-Out. That is, the control signal VHV_CNT at the H level is output. On the other hand, when the control signal CNT3 at the H level is input to the VHV control signal output circuit 470, the terminal VHV_CNT-Out is set to Hi-Z.

The control signal CNT4 is input to the state signal input/output circuit 480. The state signal input/output circuit 480, which outputs the state signal BUSY indicating the operation state of the drive circuit 51, outputs the state signal BUSY from a terminal BUSY-Out and inputs the signal input to the terminal BUSY-Out to the register control circuit 440, based on the control signal CNT4 output from the register control circuit 440. When the control signal CNT4 at the L level is input to the state signal input/output circuit 480, the voltage GVDD is supplied to the terminal BUSY-Out. That is, the state signal BUSY at the H level is output. On the other hand, when the control signal CNT4 at the H level is input to the state signal input/output circuit 480, the terminal BUSY-Out is set to Hi-Z.

The control signal CNT5 is input to the error signal input/output circuit 490. The error signal input/output circuit 490 outputs the error signal ERR indicating whether or not an abnormality has occurred in the drive circuit 51. The error signal input/output circuit 490 outputs the error signal ERR from the terminal ERR-Out and inputs the signal input to a terminal ERR-Out to the register control circuit 440, based on the control signal CNT5 output from the register control circuit 440. When the control signal CNT5 at the L level is input to the error signal input/output circuit 490, the voltage GVDD is supplied to the terminal ERR-Out. That is, the error signal ERR at the H level is output. On the other hand, when the control signal CNT5 at the H level is input to the error signal input/output circuit 490, the terminal ERR-Out is set to Hi-Z.

The control signal CNT6 is input to the amplification control signal generation circuit 502. When the control signal CNT6 is input to the amplification control signal generation circuit 502, the waveform of the drive signal COM generated by the drive signal generation circuit 501 is defined by the control signal CNT6, regardless of the drive data signal DATAX. Specifically, the drive signal generation circuit 501 generates the drive signal COM that is constant at a predetermined voltage value, based on the control signal CNT6. In addition, the drive signal generation circuit 501 may generate the drive signal COM that is constant at the ground potential, based on the control signal CNT6.

In the drive circuit 51 configured in this manner, the operation information input as the drive data signal DATAX in synchronization with the clock signal MCK is held in the sequence register 441. The operation information includes information corresponding to the command for giving the instruction to start up the drive circuit 51. Then, the register control section 443 executes sequence control of the drive circuit 51 based on the operation information held in the sequence register 441. Then, various types of sequence control including the above-described control of the startup sequence are executed, so that information indicating the operation mode accompanying the execution of the sequence control is held in the state register 442. The register control circuit 440 controls the output of the control signals CNT1 to CNT6, based on the information indicating the operation mode held in the state register 442. As a result, various signals output from the drive circuit 51 are controlled. For example, the register control circuit 440 may control the output of the control signals CNT1, CNT2, CNT3, and CNT5, based on the error signal FES or the signal input to the terminal ERR-Out.

### 1-6. Startup Sequence of Drive Circuit

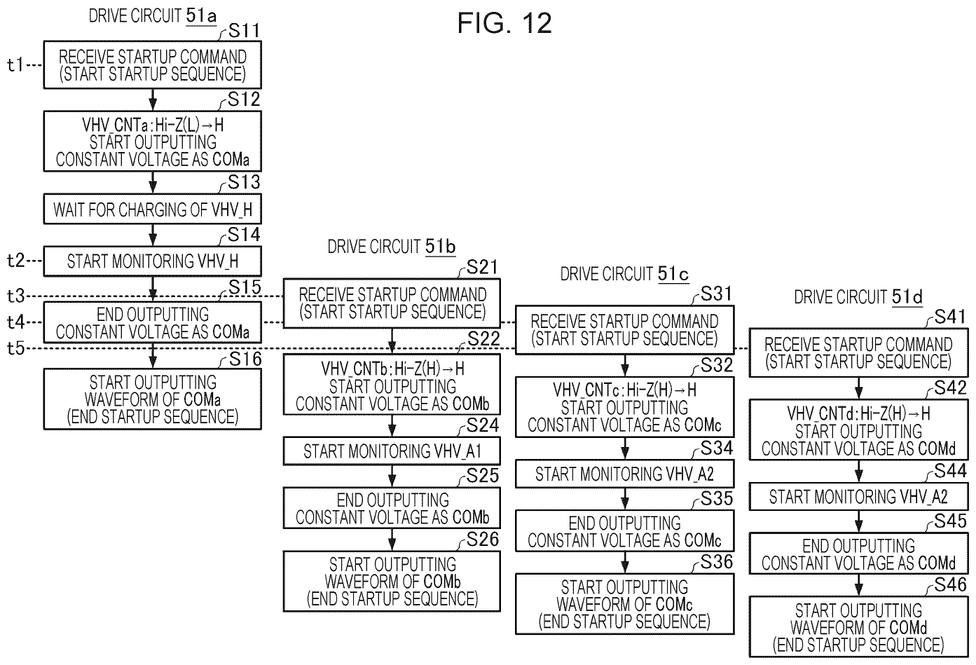

Next, the startup sequences of the drive circuits 51a, 51b, 51c, and 51d will be described in detail with reference to FIG. 12. FIG. 12 is a diagram illustrating an example of the startup sequences of the drive circuits 51a, 51b, 51c, and 51d. As illustrated in FIG. 12, the drive circuit 51a, among the drive circuits 51a, 51b, 51c, and 51d, first executes the startup sequence.

Immediately before starting the startup sequence, the drive circuit 51a sets the terminal ERR-Out and the terminal VHV_CNT-Out to Hi-Z and stops outputting the drive waveform of the drive signal COMa. First, at time t1, the drive circuit 51a receives a startup command from the startup control circuit 80 as the data signal DATAXa, and starts the startup sequence (step S11). Next, the drive circuit 51a outputs the control signal VHV_CNTa at the H level and starts outputting a constant voltage as the drive signal COMa (step S12). Next, the drive circuit 51a waits for charging to be completed until the voltage VHV_H reaches a desired voltage (step S13), and starts monitoring the voltage VHV_H at time t2 (step S14). Then, the drive circuit 51a ends outputting the constant voltage as the drive signal COMa (step S15). Finally, the drive circuit 51a starts outputting the drive waveform of the drive signal COMa and ends the startup sequence (step S16).

Immediately before starting the startup sequence, the drive circuit 51b sets the terminal ERR-Out and the terminal VHV_CNT-Out to Hi-Z and stops outputting the drive waveform of the drive signal COMb. First, at time t3 after the time t2, the drive circuit 51b receives a startup command from the startup control circuit 80 as the data signal DATAXb, and starts the startup sequence (step S21). Next, the drive circuit 51b outputs the control signal VHV_CNTb at the H level and starts outputting a constant voltage as the drive signal COMb (step S22). Then, the drive circuit 51b starts monitoring the voltage VHV_A1 (step S24). Then, the drive circuit 51b ends outputting the constant voltage as the drive signal COMb (step S25). Finally, the drive circuit 51b starts outputting the drive waveform of the drive signal COMb and ends the startup sequence (step S26).

Immediately before starting the startup sequence, the drive circuit 51c sets the terminal ERR-Out and the terminal VHV_CNT-Out to Hi-Z and stops outputting the drive waveform of the drive signal COMc. First, at time t4 after the time t3, the drive circuit 51c receives a startup command from the startup control circuit 80 as the data signal DATAXc, and starts the startup sequence (step S31). Next, the drive circuit 51c outputs the control signal VHV_CNTc at the H level and starts outputting a constant voltage as the drive signal COMc (step S32). Then, the drive circuit 51c starts monitoring the voltage VHV_A2 (step S34). Then, the drive circuit 51c ends outputting the constant voltage as the drive signal COMc (step S35). Finally, the drive circuit 51c starts outputting the drive waveform of the drive signal COMc and ends the startup sequence (step S36).

Immediately before starting the startup sequence, the drive circuit 51d sets the terminal ERR-Out and the terminal VHV_CNT-Out to Hi-Z and stops outputting the drive waveform of the drive signal COMd. First, at time t5 after the time t4, the drive circuit 51d receives a startup command from the startup control circuit 80 as the data signal DATAXd, and starts the startup sequence (step S41). Next, the drive circuit 51d outputs the control signal VHV_CNTd at the H level and starts outputting a constant voltage as the drive signal COMd (step S42). Then, the drive circuit 51d starts monitoring the voltage VHV_A2 (step S44). Then, the drive circuit 51d ends outputting the constant voltage as the drive signal COMd (step S45). Finally, the drive circuit 51d starts outputting the drive waveform of the drive signal COMd and ends the startup sequence (step S46).

The times t3, t4, and t5 at which the drive circuits 51b, 51c, and 51d start the startup sequence need only be later than the time t1 at which the drive circuit 51a starts the startup sequence, but are preferably after the time t2 at which the drive circuit 51a starts monitoring the voltage VHV_H.

The transport mechanism 4 is an example of a “transport section”. In addition, the print head 22 is an example of a “head”. Further, the voltage VHV_H is an example of a “head power supply signal”, and the voltage VHV_A1 is an example of a “drive circuit power supply signal”. Furthermore, the drive circuit 51a is an example of a “first drive circuit”, the drive circuit 51b is an example of a “second drive circuit”, and the drive circuit 51c is an example of a “third drive circuit”. Furthermore, the drive signal COMa is an example of a “first drive signal”, the drive signal COMb is an example of a “second drive signal”, and the drive signal COMc is an example of a “third drive signal”. Furthermore, the discharge section 600a is an example of a “first discharge section”, the discharge section 600b is an example of a “second discharge section”, and the discharge section 600c is an example of a “third discharge section”. Furthermore, the piezoelectric element 60a is an example of a “first drive section”, the piezoelectric element 60b is an example of a “second drive section”, and the piezoelectric element 60c is an example of a “third drive section”.

### 1-7. Operation and Effect

As described above, in the liquid discharge apparatus 1 according to the first embodiment, the drive circuit 51a that monitors the voltage VHV_H supplied to the print head 22 starts the startup sequence earlier than the drive circuit 51b that monitors the voltage VHV_A1 supplied to the drive circuits 51a and 51b, or the drive circuits 51c and 51d that monitor the voltage VHV_A2 supplied to the drive circuits 51c and 51d. Therefore, the drive circuit 51a starts monitoring the voltage VHV_H before the drive circuits 51b, 51c, and 51d start outputting the drive signals COMb, COMc, and COMd, respectively, to the print head 22. In addition, the drive circuit 51a starts monitoring the voltage VHV_H before the output of the drive signal COMa to the print head 22 is started. When the drive circuit 51a detects the decrease in the voltage VHV_H, the output of the drive signals COMa, COMb, COMc, and COMd respectively from the drive circuits 51a, 51b, 51c, and 51d to the print head 22 is immediately stopped. Therefore, with the liquid discharge apparatus 1 according to the first embodiment, a likelihood that the drive signals COMa, COMb, COMc, and COMd become higher than the voltage VHV_H can be reduced not only during a steady operation of the drive circuits 51a, 51b, 51c, and 51d but also during the startup of the drive circuits 51a, 51b, 51c, and 51d, so that a likelihood that the head fails is reduced.

However, when the supply of the voltages VHV_H, VHV_A1, and VHV_A2 to the print head 22 is stopped, the capacitance values of the capacitors 76b and 76c for stabilization are higher than the capacitance value of the capacitor 76a, so that the voltage VHV_H decreases faster than the voltages VHV_A1 and VHV_A2, and the voltages of the drive signals COMa, COMb, COMc, and COMd may be higher than the voltage VHV_H. In addition, overshoot may occur in the drive signals COMa, COMb, COMc, and COMd due to the inductance of the propagation path, and the voltages of the drive signals COMa, COMb, COMc, and COMd may be higher than the voltage VHV_H. As a result a probability that, due to the parasitic diode inside the print head 22, an excessive current flows from each of the drive signal wirings through which the drive signals COMa, COMb, COMc, and COMd propagate to the power supply wiring 75a through which the voltage VHV_H propagates, to cause the failure of the print head 22 is not zero.

When the print head 22 fails and the current flowing through the power supply wiring 75a is equal to or higher than the predetermined value, the overcurrent protection circuits 70a, 70b, and 70c switch from the conduction mode to the non-conduction mode, so that various circuits and electronic components such as the drive circuits 51a, 51b, 51c, and 51d included in the drive circuit substrate 50 can be protected. In addition, the overcurrent protection circuits 70a, 70b, and 70c are not fuses that are melted by a large current, and can switch from the non-conduction mode to the conduction mode, so that the overcurrent protection circuits 70a, 70b, and 70c can be reused. Therefore, with the liquid discharge apparatus 1 according to the first embodiment, in the head unit 20, the drive circuit substrate 50 does not need to be replaced when the print head 22 fails, and thus the effort and cost required for repair are reduced.

In addition, with the liquid discharge apparatus 1 according to the first embodiment, the overcurrent protection circuits 70a, 70b, and 70c can maintain the non-conduction mode since the input of the enable signal is stopped when switching from the conduction mode to the non-conduction mode, and a likelihood of unintentionally returning to the conduction mode is also reduced since the conduction mode is not switched from the non-conduction mode unless the predetermined signal is input.

### 2. Second Embodiment

Hereinafter, the same components of a second embodiment as the components of the first embodiment will be denoted by the same reference numerals, the description overlapping with the first embodiment will be omitted or simplified, and different contents from the first embodiment will be mainly described.

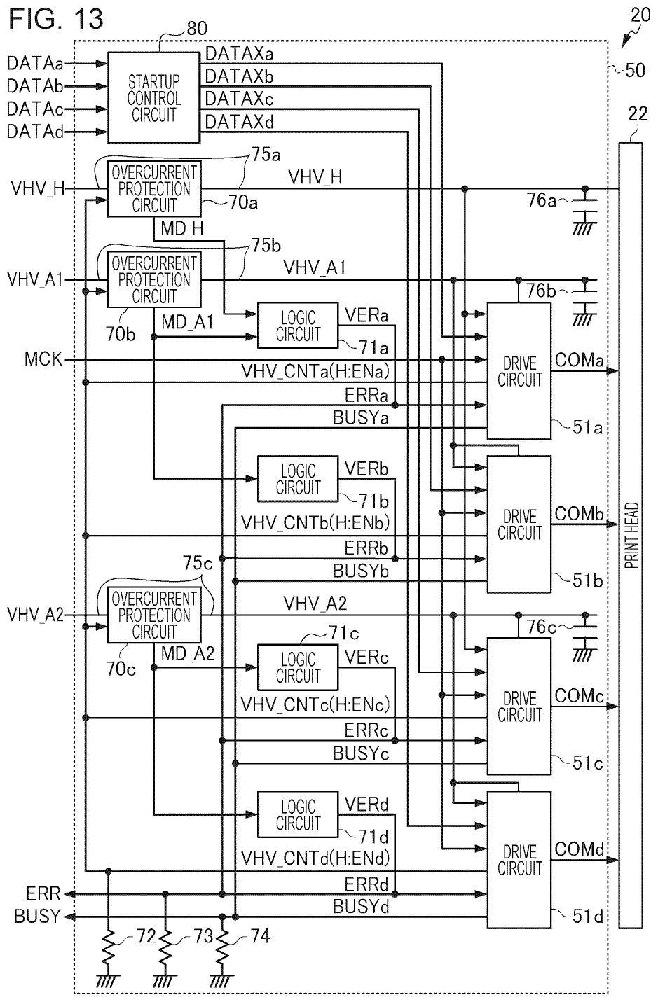

In the liquid discharge apparatus 1 according to the second embodiment, a circuit configuration and an operation of the drive circuit substrate 50 are different from the circuit configuration and the operation of the liquid discharge apparatus 1 according to the first embodiment. FIG. 13 is a block diagram illustrating a circuit configuration of the drive circuit substrate 50 in the second embodiment.

In the second embodiment, as illustrated in FIG. 13, the drive circuit 51c monitors the voltage VHV_H instead of monitoring the voltage VHV_A2. Then, the drive circuit 51c outputs the error signal ERRc at the L level when the voltage VHV_H is higher than a predetermined voltage, and outputs the error signal ERRc at the H level and stops outputting the drive waveform of the drive signal COMc when the voltage VHV_H is equal to or lower than the predetermined voltage. In addition, the error signal ERRc at the H level is a signal for stopping the output of the voltage VHV_H from the power supply circuit 90, and the power supply circuit 90 stops outputting the voltage VHV_H when the error signal ERRc is at the H level. For example, when the overcurrent protection circuit 70a switches from the conduction mode to the non-conduction mode, the voltage VHV_H monitored by the drive circuit 51c is equal to or lower than the predetermined voltage, and thus the drive circuit 51c outputs the error signal ERRc at the H level. When the voltage VHV_H is equal to or lower than the predetermined voltage, the drive circuit 51c may output the error signal ERRc at the H level and output the control signal VHV_CNTc at the L level. In this way, the drive circuit 51c operates in the same manner as the drive circuit 51a. That is, in the second embodiment, two drive circuits 51a and 51c monitor the voltage VHV_H.

When the head unit 20 is started up, the startup control circuit 80 first starts up at least one of the drive circuits 51a and 51c that monitor the voltage VHV_H among the drive circuits 51a, 51b, 51c, and 51d. That is, the startup control circuit 80 starts the startup sequence of at least one of the drive circuits 51a and 51c, and then starts the startup sequences of the drive circuits 51b and 51d. For example, the startup control circuit 80 may start the startup sequence of the drive circuit 51a and then start the startup sequences of the drive circuits 51b, 51c, and 51d, may start the startup sequence of the drive circuit 51c and then start the startup sequences of the drive circuits 51a, 51b, and 51d, or may start the startup sequences of the drive circuits 51a and 51c at the same time and then start the startup sequences of the drive circuits 51b and 51d. A time at which the drive circuits 51b and 51d start the startup sequence is preferably after a time at which at least one of the drive circuits 51a and 51c starts monitoring the voltage VHV_H.

Since the other circuit configurations of the drive circuit substrate 50 in the second embodiment are the same as circuit configurations of the drive circuit substrate 50 in the first embodiment illustrated in FIG. 9, the description thereof will be omitted. In addition, since other configurations and functions of the liquid discharge apparatus 1 according to the second embodiment are the same as the configurations and functions of the liquid discharge apparatus 1 according to the first embodiment, the description thereof will be omitted.

In the liquid discharge apparatus 1 according to the second embodiment described above, at least one of the drive circuits 51a and 51c that monitor the voltage VHV_H supplied to the print head 22 starts the startup sequence earlier than the drive circuit 51b that monitors the voltage VHV_A1 supplied to the drive circuits 51a and 51b, or the drive circuit 51d that monitors the voltage VHV_A2 supplied to the drive circuits 51c and 51d. Therefore, at least one of the drive circuits 51a and 51c starts monitoring the voltage VHV_H before the drive circuits 51b and 51d start outputting the drive signals COMb and COMd, respectively, to the print head 22. In addition, the drive circuits 51a and 51c starts monitoring the voltage VHV_H before the output of the drive signals COMa and COMc to the print head 22 is started. When at least one of the drive circuits 51a and 51b detects the decrease in the voltage VHV_H, the output of the drive signals COMa, COMb, COMc, and COMd respectively from the drive circuits 51a, 51b, 51c, and 51d to the print head 22 is immediately stopped. Therefore, with the liquid discharge apparatus 1 according to the second embodiment, a likelihood that the drive signals COMa, COMb, COMc, and COMd become higher than the voltage VHV_H can be reduced not only during a steady operation of the drive circuits 51a, 51b, 51c, and 51d but also during the startup of the drive circuits 51a, 51b, 51c, and 51d, so that a likelihood that the head fails is reduced.

When the print head 22 fails and the current flowing through the power supply wiring 75a is equal to or higher than the predetermined value, the overcurrent protection circuits 70a, 70b, and 70c switch from the conduction mode to the non-conduction mode, so that various circuits and electronic components such as the drive circuits 51a, 51b, 51c, and 51d included in the drive circuit substrate 50 can be protected. In addition, the overcurrent protection circuits 70a, 70b, and 70c are not fuses that are melted by a large current, and can switch from the non-conduction mode to the conduction mode, so that the overcurrent protection circuits 70a, 70b, and 70c can be reused. Therefore, with the liquid discharge apparatus 1 according to the second embodiment, in the head unit 20, the drive circuit substrate 50 does not need to be replaced when the print head 22 fails, and thus the effort and cost required for repair are reduced.

In addition, with the liquid discharge apparatus 1 according to the second embodiment, the overcurrent protection circuits 70a, 70b, and 70c can maintain the non-conduction mode since the input of the enable signal is stopped when switching from the conduction mode to the non-conduction mode, and a likelihood of unintentionally returning to the conduction mode is also reduced since the conduction mode is not switched from the non-conduction mode unless the predetermined signal is input.

### 3. Third Embodiment

Hereinafter, the same components of a third embodiment as the components of the first embodiment or the second embodiment will be denoted by the same reference numerals, the description overlapping with the first embodiment or the second embodiment will be omitted or simplified, and different contents from the first embodiment or the second embodiment will be mainly described.

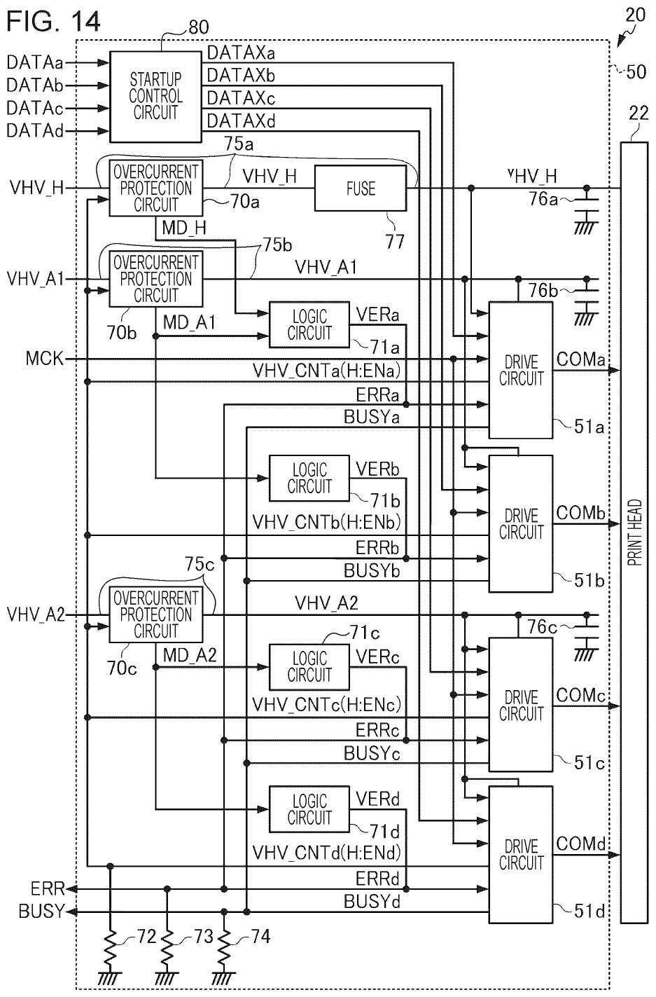

In the liquid discharge apparatus 1 according to the third embodiment, a circuit configuration and an operation of the drive circuit substrate 50 are different from the circuit configuration and the operation of the liquid discharge apparatus 1 according to the first embodiment or the second embodiment. FIG. 14 is a block diagram illustrating a circuit configuration of the drive circuit substrate 50 in the third embodiment.

In the third embodiment, as illustrated in FIG. 14, the drive circuit substrate 50 includes a fuse 77. The fuse 77 is provided on the power supply wiring 75a through which the voltage VHV_H is supplied to the print head 22. Specifically, the fuse 77 has one end coupled to an output end of the overcurrent protection circuit 70a, and the other end coupled to the print head 22. Therefore, the voltage VHV_H is supplied from the other end of the fuse 77 to the print head 22.

The drive circuit 51a monitors the voltage VHV_H propagating through a portion between the fuse 77 of the power supply wiring 75a and the print head 22, and, when the voltage VHV_H is equal to or lower than a predetermined voltage, the drive circuit 51a outputs the error signal ERRa at the H level and stops outputting the drive waveform of the drive signal COMa. In addition, the error signal ERRa at the H level is a signal for stopping the output of the voltage VHV_H from the power supply circuit 90, and the power supply circuit 90 stops outputting the voltage VHV_H when the error signal ERRa is at the H level. For example, when the overcurrent protection circuit 70a switches from the conduction mode to the non-conduction mode, the voltage VHV_H monitored by the drive circuit 51a is equal to or lower than the predetermined voltage, and thus the drive circuit 51a outputs the error signal ERRa at the H level. When the voltage VHV_H is equal to or lower than the predetermined voltage, the drive circuit 51a may output the error signal ERRa at the H level and output the control signal VHV_CNTa at the L level.

Then, when the head unit 20 is started up, the startup control circuit 80 first starts up the drive circuit 51a that monitors the voltage VHV_H among the drive circuits 51a, 51b, 51c, and 51d. That is, the startup control circuit 80 starts the startup sequence of the drive circuit 51a, and then starts the startup sequences of the drive circuits 51b, 51c, and 51d. A time at which the drive circuits 51b, 51c, and 51d start the startup sequence is preferably after a time at which the drive circuit 51a starts monitoring the voltage VHV_H.

Since the other circuit configurations of the drive circuit substrate 50 in the third embodiment are the same as circuit configurations of the drive circuit substrate 50 in the first embodiment illustrated in FIG. 9, the description thereof will be omitted. In addition, since other configurations and functions of the liquid discharge apparatus 1 according to the third embodiment are the same as the configurations and functions of the liquid discharge apparatus 1 according to the first embodiment, the description thereof will be omitted.

In the third embodiment, the drive circuits 51a and 51c may monitor the voltage VHV_H propagating through the portion between the fuse 77 of the power supply wiring 75a and the print head 22, as in the drive circuit substrate 50 according to the second embodiment illustrated in FIG. 13. In such a case, when the head unit 20 is started up, the startup control circuit 80 first starts up at least one of the drive circuits 51a and 51c that monitor the voltage VHV_H among the drive circuits 51a, 51b, 51c, and 51d. That is, the startup control circuit 80 starts the startup sequence of at least one of the drive circuits 51a and 51c, and then starts the startup sequences of the drive circuits 51b and 51d. For example, the startup control circuit 80 may start the startup sequence of the drive circuit 51a and then start the startup sequences of the drive circuits 51b, 51c, and 51d, may start the startup sequence of the drive circuit 51c and then start the startup sequences of the drive circuits 51a, 51b, and 51d, or may start the startup sequences of the drive circuits 51a and 51c at the same time and then start the startup sequences of the drive circuits 51b and 51d. A time at which the drive circuits 51b and 51d start the startup sequence is preferably after a time at which at least one of the drive circuits 51a and 51c starts monitoring the voltage VHV_H.

The drive circuit substrate 50 may include, instead of the fuse 77, other elements such as ferrite beads as an element for electrically isolating the power supply circuit 90 and the print head 22.

In the liquid discharge apparatus 1 according to the third embodiment described above, similar to the liquid discharge apparatus 1 according to the first embodiment, the drive circuit 51a starts monitoring the voltage VHV_H before the drive circuits 51b, 51c, and 51d start outputting the drive signals COMb, COMc, and COMd to the print head 22. Therefore, with the liquid discharge apparatus 1 according to the third embodiment, a likelihood that the drive signals COMa, COMb, COMc, and COMd become higher than the voltage VHV_H can be reduced not only during a steady operation of the drive circuits 51a, 51b, 51c, and 51d but also during the startup of the drive circuits 51a, 51b, 51c, and 51d, so that a likelihood that the head fails is reduced.

Further, with the liquid discharge apparatus 1 according to the third embodiment, the fuse 77 is melted when an excessive current flows through the power supply wiring 75a that supplies the voltage VHV_H to the print head 22, so that a likelihood that the print head 22 fails is further reduced.

Further, with the liquid discharge apparatus 1 according to the first embodiment, the overcurrent protection circuits 70a, 70b, and 70c can maintain the non-conduction mode since the input of the enable signal is stopped when switching from the conduction mode to the non-conduction mode, and a likelihood of unintentionally returning to the conduction mode is also reduced since the conduction mode is not switched from the non-conduction mode unless the predetermined signal is input.

### 4. Fourth Embodiment

Hereinafter, the same components of a fourth embodiment as the components of the first embodiment to the third embodiment will be denoted by the same reference numerals, the description overlapping with the first embodiment to the third embodiment will be omitted or simplified, and different contents from the first embodiment to the third embodiment will be mainly described.

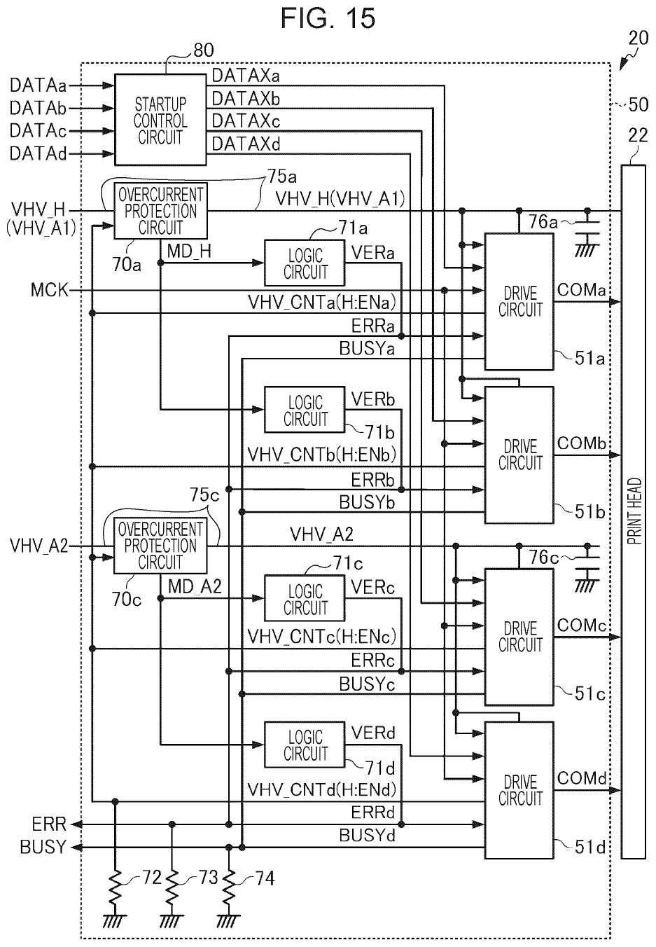

In the liquid discharge apparatus 1 according to the fourth embodiment, a circuit configuration and an operation of the drive circuit substrate 50 are different from the circuit configuration and the operation of the liquid discharge apparatus 1 according to the first embodiment to the third embodiment. FIG. 15 is a block diagram illustrating a circuit configuration of the drive circuit substrate 50 in the fourth embodiment.

In the fourth embodiment, as illustrated in FIG. 15, the voltage VHV_H supplied to the print head 22 and the voltage VHV_A1 supplied to the drive circuits 51a and 51b are common voltages.

The drive circuits 51a and 51b monitor the voltage VHV_H. Then, the drive circuits 51a and 51b output the error signals ERRa and ERRb at the L level, respectively, when the voltage VHV_H is higher than a predetermined voltage, and output the error signals ERRa and ERRb at the H level, respectively, and stop outputting the drive waveforms of the drive signals COMa and COMb, respectively, when the voltage VHV_H is equal to or lower than the predetermined voltage. Further, the error signals ERRa and ERRb at the H level are signals for stopping the output of the voltage VHV_H from the power supply circuit 90, and the power supply circuit 90 stops outputting the voltage VHV_H when at least one of the error signals ERRa and ERRb is at the H level. For example, when the overcurrent protection circuit 70a switches from the conduction mode to the non-conduction mode, the voltage VHV_H monitored by the drive circuits 51a and 51b is equal to or lower than the predetermined voltage, and thus the drive circuits 51a and 51b output the error signals ERRa and ERRb at the H level, respectively. When the voltage VHV_H is equal to or lower than the predetermined voltage, the drive circuits 51a and 51b may output the error signals ERRa and ERRb at the H level, respectively, and output the control signals VHV_CNTa and VHV_CNTb at the L level, respectively.

When the head unit 20 is started up, the startup control circuit 80 first starts up at least one of the drive circuits 51a and 51b that monitor the voltage VHV_H among the drive circuits 51a, 51b, 51c, and 51d. That is, the startup control circuit 80 starts the startup sequence of at least one of the drive circuits 51a and 51b, and then starts the startup sequences of the drive circuits 51c and 51d. For example, the startup control circuit 80 may start the startup sequence of the drive circuit 51a and then start the startup sequences of the drive circuits 51b, 51c, and 51d, may start the startup sequence of the drive circuit 51b and then start the startup sequences of the drive circuits 51a, 51c, and 51d, or may start the startup sequences of the drive circuits 51a and 51b at the same time and then start the startup sequences of the drive circuits 51c and 51d. A time at which the drive circuits 51c and 51d start the startup sequence is preferably after a time at which at least one of the drive circuits 51a and 51b starts monitoring the voltage VHV_H.

Since the other circuit configurations of the drive circuit substrate 50 in the fourth embodiment are the same as circuit configurations of the drive circuit substrate 50 in the first embodiment illustrated in FIG. 9, the description thereof will be omitted. In addition, since other configurations and functions of the liquid discharge apparatus 1 according to the fourth embodiment are the same as the configurations and functions of the liquid discharge apparatus 1 according to the first embodiment, the description thereof will be omitted.

In the fourth embodiment, as in the drive circuit substrate 50 according to the third embodiment illustrated in FIG. 14, the drive circuit substrate 50 may include the fuse 77 provided on the power supply wiring 75a through which the voltage VHV_H is supplied to the print head 22, and the drive circuits 51a and 51b may monitor the voltage VHV_H propagating through a portion between the fuse 77 of the power supply wiring 75a and the print head 22.

In the liquid discharge apparatus 1 according to the fourth embodiment described above, at least one of the drive circuits 51a and 51b that monitor the voltage VHV_H (VHV_A1) supplied to the print head 22 and the drive circuits 51a and 51b starts the startup sequence earlier than the drive circuits 51c and 51d that monitor the voltage VHV_A2 supplied to the drive circuits 51c and 51d. Therefore, at least one of the drive circuits 51a and 51b starts monitoring of the voltage VHV_H (VHV_A1) before the drive circuits 51c and 51d start outputting the drive signals COMc and COMd, respectively, to the print head 22. Further, the drive circuits 51a and 51b start monitoring the voltages VHV_H (VHV_A1) before the drive circuits 51a and 51b start outputting the drive signals COMa and COMb to the print head 22. When at least one of the drive circuits 51a and 51b detects the decrease in the voltage VHV_H (VHV_A1), the output of the drive signals COMa, COMb, COMc, and COMd respectively from the drive circuits 51a, 51b, 51c, and 51d to the print head 22 is immediately stopped. Therefore, with the liquid discharge apparatus 1 according to the fourth embodiment, a likelihood that the drive signals COMa, COMb, COMc, and COMd become higher than the voltage VHV_H (VHV_A1) can be reduced not only during a steady operation of the drive circuits 51a, 51b, 51c, and 51d but also during the startup of the drive circuits 51a, 51b, 51c, and 51d, so that a likelihood that the head fails is reduced.

When the print head 22 fails and the current flowing through the power supply wiring 75a is equal to or higher than the predetermined value, the overcurrent protection circuits 70a, 70b, and 70c switch from the conduction mode to the non-conduction mode, so that various circuits and electronic components such as the drive circuits 51a, 51b, 51c, and 51d included in the drive circuit substrate 50 can be protected. In addition, the overcurrent protection circuits 70a, 70b, and 70c are not fuses that are melted by a large current, and can switch from the non-conduction mode to the conduction mode, so that the overcurrent protection circuits 70a, 70b, and 70c can be reused. Therefore, with the liquid discharge apparatus 1 according to the fourth embodiment, in the head unit 20, the drive circuit substrate 50 does not need to be replaced when the print head 22 fails, and thus the effort and cost required for repair are reduced.

In addition, with the liquid discharge apparatus 1 according to the fourth embodiment, the overcurrent protection circuits 70a, 70b, and 70c can maintain the non-conduction mode since the input of the enable signal is stopped when switching from the conduction mode to the non-conduction mode, and a likelihood of unintentionally returning to the conduction mode is also reduced since the conduction mode is not switched from the non-conduction mode unless the predetermined signal is input.

### 5. Modification Example

The present disclosure is not limited to the embodiments described herein, and various modifications may be made within the scope of the gist of the present disclosure.

For example, in each of the embodiments described above, the drive circuit substrate 50 includes four drive circuits 51, but the number of drive circuits 51 included in the drive circuit substrate 50 may be two, three, or five or more. Similarly, although the drive circuit substrate 50 includes four overcurrent protection circuits 70, the number of overcurrent protection circuits 70 included in the drive circuit substrate 50 may be two, three, or five or more.

In addition, in each of the embodiments described above, the VHV abnormality signals VERa, VERb, VERc, and VERd output from the logic circuits 71a, 71b, 71c, and 71d are input to the drive circuits 51a, 51b, 51c, and 51d as the error signals ERRa, ERRb, ERRc, and ERRd, respectively, but the VHV abnormality signals VERa output from the logic circuit 71a as the error signals ERRa, ERRb, ERRc, and ERRd may be commonly input to the drive circuits 51a, 51b, 51c, and 51d.

In addition, in each of the embodiments described above, the liquid discharge apparatus 1 is described as a so-called serial type ink jet printer in which the liquid discharge module 21 that discharges ink is mounted on the carriage 24 and the carriage 24 reciprocates on the medium P to perform printing, but the liquid discharge apparatus 1 may be a so-called line type ink jet printer in which the liquid discharge modules 21 are arranged side by side in a width direction of the medium P and printing is performed by transporting the medium P.

Hereinabove, the embodiments are described, but the present disclosure is not limited to these embodiments, and can be carried out in various aspects without departing from the gist thereof. For example, the embodiments described above can also be combined with each other as appropriate.

The present disclosure includes substantially the same configuration as the configurations described in the embodiments, for example, the configuration having the same function, method, and result, or configurations having the same object and effect. Further, the present disclosure includes a configuration in which non-essential parts of the configuration described in the embodiments are replaced. In addition, the present disclosure includes a configuration that achieve the same operations and effect or a configuration that can achieve the same object as the configurations described in the embodiments. Further, the present disclosure includes a configuration in which a known technology is added to the configurations described in the embodiments.

The following contents are derived from the embodiments described above.

According to an aspect of the present disclosure, there is provided a liquid discharge apparatus including: a head including a first discharge section that includes a first drive section driven by a first drive signal and that discharges liquid onto a medium in response to driving of the first drive section, and a second discharge section that includes a second drive section driven by a second drive signal and that discharges liquid onto the medium in response to driving of the second drive section; a transport section that transports the medium; a first drive circuit that outputs the first drive signal; a second drive circuit that outputs the second drive signal; and a startup control circuit that controls startup of the first drive circuit and the second drive circuit, in which a head power supply signal is supplied to the head, a drive circuit power supply signal is supplied to the first drive circuit and the second drive circuit, the first drive circuit outputs a signal for stopping output of the head power supply signal from a power supply circuit when the head power supply signal is equal to or lower than a predetermined voltage, the second drive circuit outputs a signal for stopping output of the drive circuit power supply signal from the power supply circuit when the drive circuit power supply signal is equal to or lower than a predetermined voltage, and the startup control circuit starts a startup sequence of the first drive circuit, and then starts a startup sequence of the second drive circuit.

In such a liquid discharge apparatus, the first drive circuit that monitors the voltage of the head power supply signal starts the startup sequence earlier than the second drive circuit that monitors the voltage of the drive circuit power supply signal, so that the first drive circuit starts monitoring the voltage of the head power supply signal before the second drive circuit starts outputting the second drive signal to the head. Therefore, with such a liquid discharge apparatus, it is possible to reduce a likelihood that the voltage of the second drive signal is higher than the voltage of the head power supply signal when the first drive circuit and the second drive circuit are started up, so that a likelihood that the head fails is reduced.

The liquid discharge apparatus according to the aspect may further include: a third discharge section that includes a third drive section driven by a third drive signal and that discharges liquid onto the medium in response to driving of the third drive section; and a third drive circuit that outputs the third drive signal, in which the third drive circuit outputs a signal for stopping output of the head power supply signal from the power supply circuit when the head power supply signal is equal to or lower than a predetermined voltage, and the startup control circuit starts a startup sequence of at least one of the first drive circuit and the third drive circuit, and then starts the startup sequence of the second drive circuit.

In such a liquid discharge apparatus, at least one of the first drive circuit and the third drive circuit that monitor the voltage of the head power supply signal starts the startup sequence earlier than the second drive circuit that monitors the voltage of the drive circuit power supply signal, so that at least one of the first drive circuit and the third drive circuit starts monitoring the voltage of the drive circuit power supply signal before the second drive circuit starts outputting the second drive signal to the head. Therefore, with such a liquid discharge apparatus, it is possible to reduce a likelihood that the voltage of the second drive signal is higher than the voltage of the head power supply signal when the first drive circuit, the second drive circuit, and third drive circuit are started up, so that a likelihood that the head fails is reduced.

In the liquid discharge apparatus according to the aspect, the drive circuit power supply signal may be a signal different from the head power supply signal, and may not be supplied to the head.

The liquid discharge apparatus according to the aspect may further include: a fuse provided on a power supply wiring through which the head power supply signal is supplied to the head, in which the first drive circuit outputs the signal for stopping output of the head power supply signal from the power supply circuit when the head power supply signal propagating through a portion of the power supply wiring between the fuse and the head is equal to or lower than the predetermined voltage.

With such a liquid discharge apparatus, the fuse is melted when an excessive current flows through the power supply wiring through which the head power supply signal is supplied to the head, so that a likelihood that the head fails is further reduced.

According to another aspect, there is provided a head unit including: a head including a first discharge section that includes a first drive section driven by a first drive signal and that discharges liquid onto a medium in response to driving of the first drive section, and a second discharge section that includes a second drive section driven by a second drive signal and that discharges liquid onto the medium in response to driving of the second drive section; a first drive circuit that outputs the first drive signal; a second drive circuit that outputs the second drive signal; and a startup control circuit that controls startup of the first drive circuit and the second drive circuit, in which a head power supply signal is supplied to the head, a drive circuit power supply signal is supplied to the first drive circuit and the second drive circuit, the first drive circuit outputs a signal for stopping output of the head power supply signal from a power supply circuit when the head power supply signal is equal to or lower than a predetermined voltage, the second drive circuit outputs a signal for stopping output of the drive circuit power supply signal from the power supply circuit when the drive circuit power supply signal is equal to or lower than a predetermined voltage, and the startup control circuit starts a startup sequence of the first drive circuit, and then starts a startup sequence of the second drive circuit.

In such a head unit, the first drive circuit that monitors the voltage of the head power supply signal starts the startup sequence earlier than the second drive circuit that monitors the voltage of the drive circuit power supply signal, so that the first drive circuit starts monitoring the voltage of the head power supply signal before the second drive circuit starts outputting the second drive signal to the head. Therefore, with such a head unit, it is possible to reduce a likelihood that the voltage of the second drive signal is higher than the voltage of the head power supply signal when the first drive circuit and the second drive circuit are started up, so that a likelihood that the head fails is reduced.

The head unit according to the aspect may further include: a third discharge section that includes a third drive section driven by a third drive signal and that discharges liquid onto the medium in response to driving of the third drive section; and a third drive circuit that outputs the third drive signal, in which the third drive circuit outputs a signal for stopping output of the head power supply signal from the power supply circuit when the head power supply signal is equal to or lower than a predetermined voltage, and the startup control circuit starts a startup sequence of at least one of the first drive circuit and the third drive circuit, and then starts the startup sequence of the second drive circuit.

In such a head unit, at least one of the first drive circuit and the third drive circuit that monitor the voltage of the head power supply signal starts the startup sequence earlier than the second drive circuit that monitors the voltage of the drive circuit power supply signal, so that at least one of the first drive circuit and the third drive circuit starts monitoring the voltage of the drive circuit power supply signal before the second drive circuit starts outputting the second drive signal to the head. Therefore, with such a head unit, it is possible to reduce a likelihood that the voltage of the second drive signal is higher than the voltage of the head power supply signal when the first drive circuit, the second drive circuit, and third drive circuit are started up, so that a likelihood that the head fails is reduced.

In the head unit according to the aspect, the drive circuit power supply signal may be a signal different from the head power supply signal, and may not be supplied to the head.

The head unit according to the aspect may further include: a fuse provided on a power supply wiring through which the head power supply signal is supplied to the head, in which the first drive circuit outputs the signal for stopping output of the head power supply signal from the power supply circuit when the head power supply signal propagating through a portion of the power supply wiring between the fuse and the head is equal to or lower than the predetermined voltage.

With such a head unit, the fuse is melted when an excessive current flows through the power supply wiring through which the head power supply signal is supplied to the head, so that a likelihood that the head fails is further reduced.

What is claimed is:

1. A liquid discharge apparatus comprising:
a head including
a first discharge section that includes a first drive section driven by a first drive signal and that discharges liquid onto a medium in response to driving of the first drive section, and
a second discharge section that includes a second drive section driven by a second drive signal and that discharges liquid onto the medium in response to driving of the second drive section;
a transport section that transports the medium;
a first drive circuit that outputs the first drive signal;
a second drive circuit that outputs the second drive signal; and
a startup control circuit that controls startup of the first drive circuit and the second drive circuit, wherein
a head power supply signal is supplied to the head,
a drive circuit power supply signal is supplied to the first drive circuit and the second drive circuit,
the first drive circuit outputs a signal for stopping output of the head power supply signal from a power supply circuit when the head power supply signal is equal to or lower than a predetermined voltage,
the second drive circuit outputs a signal for stopping output of the drive circuit power supply signal from the power supply circuit when the drive circuit power supply signal is equal to or lower than a predetermined voltage, and
the startup control circuit starts a startup sequence of the first drive circuit, and then starts a startup sequence of the second drive circuit.

2. The liquid discharge apparatus according to claim 1, further comprising:
a third discharge section that includes a third drive section driven by a third drive signal and that discharges liquid onto the medium in response to driving of the third drive section; and
a third drive circuit that outputs the third drive signal, wherein
the third drive circuit outputs a signal for stopping output of the head power supply signal from the power supply circuit when the head power supply signal is equal to or lower than a predetermined voltage, and
the startup control circuit starts a startup sequence of at least one of the first drive circuit and the third drive circuit, and then starts the startup sequence of the second drive circuit.

3. The liquid discharge apparatus according to claim 1, wherein
the drive circuit power supply signal is a signal different from the head power supply signal, and is not supplied to the head.

4. The liquid discharge apparatus according to claim 1, further comprising:
a fuse provided on a power supply wiring through which the head power supply signal is supplied to the head, wherein
the first drive circuit outputs the signal for stopping output of the head power supply signal from the power supply circuit when the head power supply signal propagating through a portion of the power supply wiring between the fuse and the head is equal to or lower than the predetermined voltage.

5. A head unit comprising:
a head including
a first discharge section that includes a first drive section driven by a first drive signal and that discharges liquid onto a medium in response to driving of the first drive section, and
a second discharge section that includes a second drive section driven by a second drive signal and that discharges liquid onto the medium in response to driving of the second drive section;
a first drive circuit that outputs the first drive signal;
a second drive circuit that outputs the second drive signal; and
a startup control circuit that controls startup of the first drive circuit and the second drive circuit, wherein
a head power supply signal is supplied to the head,
a drive circuit power supply signal is supplied to the first drive circuit and the second drive circuit,
the first drive circuit outputs a signal for stopping output of the head power supply signal from a power supply circuit when the head power supply signal is equal to or lower than a predetermined voltage,
the second drive circuit outputs a signal for stopping output of the drive circuit power supply signal from the power supply circuit when the drive circuit power supply signal is equal to or lower than a predetermined voltage, and
the startup control circuit starts a startup sequence of the first drive circuit, and then starts a startup sequence of the second drive circuit.

6. The head unit according to claim 5, further comprising:
a third discharge section that includes a third drive section driven by a third drive signal and that discharges liquid onto the medium in response to driving of the third drive section; and
a third drive circuit that outputs the third drive signal, wherein
the third drive circuit outputs a signal for stopping output of the head power supply signal from the power supply circuit when the head power supply signal is equal to or lower than a predetermined voltage, and
the startup control circuit starts a startup sequence of at least one of the first drive circuit and the third drive circuit, and then starts the startup sequence of the second drive circuit.

7. The head unit according to claim 5, wherein
the drive circuit power supply signal is a signal different from the head power supply signal, and is not supplied to the head.

8. The head unit according to claim 5, further comprising:
a fuse provided on a power supply wiring through which the head power supply signal is supplied to the head, wherein
the first drive circuit outputs the signal for stopping output of the head power supply signal from the power supply circuit when the head power supply signal propagating through a portion of the power supply wiring between the fuse and the head is equal to or lower than the predetermined voltage.
